(19) United States
(12) Patent Application Publication
(10) Pub. No.: US 2016/0244312 A1
(43) Pub. Date: Aug. 25, 2016

(54) Counter Water Bottle Dispenser

(71) Applicant: Kenneth John Gallagher, Las Vegas, NV (US)

(72) Inventor: Kenneth John Gallagher, Las Vegas, NV (US)

(21) Appl. No.: 15/017,613

(22) Filed: Feb. 6, 2016

Related U.S. Application Data
(60) Provisional application No. 62/119,116, filed on Feb. 21, 2015.
(60) Provisional application No. 62/129,839, filed on Mar. 7, 2015.
(60) Provisional application No. 62/137,577, filed on Mar. 24, 2015.
(60) Provisional application No. 62/137,627, filed on Mar. 24, 2015.

(51) Int. Cl. B67D 3/00

(52) U.S. Cl. CPC B67D 3/0035; B67D 3/0061

(57) ABSTRACT

A dispenser for delivering a liquid from a supply bottle has a base having a hollow interior. The base has a rim formed at a top portion of the base, a foot formed at a bottom portion of the base, and a window formed in the base. A removable bottle collar engages with the rim and is adapted to engage and support the supply bottle inverted and positioned within the rim. The removable bottle collar has a center aperture where a mouth of the supply bottle extends there through. The liquid from the supply bottle is delivered from the mouth of the supply bottle through the base window to a location outside the base.

### CROSS REFERENCE TO RELATED APPLICATIONS

The present application claims the benefit of U.S. Provisional Application Nos. 62/119,116, filed on 2015 Feb. 21; 62/129,839, filed on 2015 Mar. 7; 62/137,577, filed on 2015 Mar. 24; and 62/137,627 filed on 2015 Mar. 24, each entitled “COUNTER WATER BOTTLE DISPENSER” in the name of Kenneth J. Gallagher, and which is incorporated herein by reference in its entirety.

### BACKGROUND OF THE DISCLOSURE

The present application generally relates to a bottled water dispenser, and, more particularly, to water bottle holders and water bottle dispensers that provide a convenient and simplified mechanism to access bottled water in a direct manner.

With the advent of increased popularity of bottled spring water and bottled purified water here and abroad, a need may have developed for water bottle holders and water bottle dispensers that may provide a convenient and simplified mechanism to access bottled water. In the past, water may have been dispensed through a water crock or similar devices. Water crocks may be jars or containers that store water. A dispensing device may be located at the bottom of the water crock for releasing water stored within the container. Water crocks generally require filling prior to usage and generally need to be cleaned periodically. Water dispensers have evolved from the simple water crocks to bottled water dispensers ranging from the original multiple gallon glass jugs that were inverted and positioned within large free standing and often refrigerated water coolers to the more current, disposable plastic bottles and single use “gallon” plastic water jugs.

A limited number of companies of companies offer purified and spring water in countertop plastic water jug dispensers. These plastic water jug dispensers may typically require that the dispensers lay flat on the countertop, and a single use valve may be located at the bottom of the jug. Of the few brands that do offer a countertop dispenser version of their product, several problems may be associated with their dispensers. To begin with, the user generally needs to administer a vent hole in these dispensers. Unfortunately, these plastic water jug dispensers generally do not provide a piercing tool for this task. Furthermore, the single use valves that are offered with the small number of branded countertop dispensers that are on the market may be of a low quality and may often leak. Lastly, these dispensers may present a number of practical placement and use restrictions and problems.

Over the years, a variety of U.S. patents have issued on dispensing valves/valve parts, and water dispensing devices. U.S. Pat. No. 4,293,082 issued to Shinji Matsueda shows one way in which an inverted bottle can be supported by a stand that includes a thermal insulator for the inverted bottle. U.S. Pat. No. 5,123,720 issued to Blomster et al. discloses a floor based inverted water bottle stand for a 5 gallons bottle. As with the Shinji patent, the Bolomster et al. is patenting the stand that supports an inverted bottle. U.S. Pat. No. 5,647,416 issued to Desrosiers et al. discloses another patent on a stand for a 5 gallons bottle that includes a reservoir and the support housing for the reservoir.

U.S. Pat. No. 6,241,126 issued to Andrew Goodman discloses a personal beverage desktop dispenser with a cubical base and valve housed therein. The male bottle threads are mated with the female threads of the base. An issue with this embodiment is that it may be difficult to invert the entire dispenser to union it with the upright bottle since the bottle valve is secured to the base. Even if the valve was not secured to the base, the valve with the handle is too large to fit through the bottle hole in the base top. It could prove rather difficult to threadably secure an entire base onto a bottle. Moreover, the base could become unsanitary rather quickly having liquid spilled within the base and it appears to be rather difficult to clean.

U.S. Pat. No. 6,527,145 issued to Jules G. Bennett, Jr. discloses a personal desktop beverage dispenser that has a base holding an inverted bottle with the bottle male threads threadably secured to the female threads of the dispenser base. An outflow valve controls the flow of bottle contents to a cup placed beneath. While this embodiment can be used with more than one bottle size it requires having to invert the entire base and threadably secure it onto an upright bottle, which could prove to be rather difficult.

U.S. Pat. No. 6,892,903 issued to Salvatore Barolotta discloses a personal beverage bottle dispenser. The personal beverage bottle dispenser requires that the entire base be inverted and threadably secured to the upright bottle in order to union the bottle with the valve.

U.S. Pat. No. 3,104,089 issued to Harold O. Seltsam, shows a self-closing lift type faucet adapted for use with water crocks, certain coolers, and beverage dispensers. Similarly, U.S. Pat. No. 3,207,472 issued Sep. 25, 1965 to Seltsam shows a tubular diaphragm valve. As with the self-closing valve, this valve is again configured for use with water crocks, certain coolers, and beverage dispensers.

### SUMMARY OF THE DISCLOSURE

In accordance with one embodiment, a dispenser for delivering liquid from a supply bottle is disclosed. The dispenser has a base having a hollow interior. The base has a rim formed at a top portion of the base, a foot formed at a bottom portion of the base, and a window formed in the base. A removable bottle collar engages with the rim and is adapted to engage and support the supply bottle inverted and positioned within the rim. The removable bottle collar has a center aperture where a mouth of the supply bottle extends there through. The liquid from the supply bottle is delivered from the mouth of the supply bottle through the base window to a location outside the base.

In accordance with one embodiment, a dispenser for delivering a liquid from a supply bottle is disclosed. The dispenser has a walled base having a hollow interior. A rim is formed at a top portion of the walled base. A foot is formed at a bottom portion of the walled base. A window is formed in a side of the walled base. A removable bottle collar engages with the rim and is adapted to engage and support the supply bottle inverted and positioned within the rim. The removable bottle collar has a center aperture where a mouth of the supply bottle extends there through. The liquid from the supply bottle is delivered from the mouth of the supply bottle through the walled base window to a location outside of the walled base. A top enclosure of the bottle collar is formed to engage the supply bottle. The top enclosure surrounds a portion of a sidewall of a body of the supply bottle. The top enclosure restricts a lateral movement of the supply bottle inverted and positioned within the top enclosure. A bottle seat merges with the top enclosure. The bottle seat is formed to removably engage the supply bottle. The bottle seat has the center aperture where the mouth of the supply bottle extends through when the supply bottle is inverted and positioned on the bottle seat. An outer portion of the bottle collar merges with the bottle seat. The outer portion of the bottle collar is formed to removably engage upon the rim. A bottom ring merges with the outer portion of the bottle collar. The bottom ring is formed to restrict a lateral movement of the bottle collar upon the rim.

In accordance with one embodiment, a dispenser for delivering a liquid from an inverted supply bottle is disclosed. The dispenser has a valve. The dispenser valve has a body. An inlet port of the valve body has a threaded inlet port top. An outlet port of the valve body is in liquid communication with the inlet port. The outlet port is located to a side of the inlet port when the dispenser valve is coupled to a mouth of the inverted supply bottle. A sealing seat is in liquid communication with the inlet and outlet ports. A component compartment has a threaded top. A component compartment bonnet having a center aperture is threadably secured to the threaded component compartment top. A seat cup contiguous with the component compartment bonnet is housed within the component compartment. The seat cup controls a flow of the liquid through the dispenser valve. The liquid flowing through the dispenser valve is halted when the seat cup is urged upon the sealing seat. A peg is housed within the component compartment. A base of the peg is anchored within the seat cup. A slotted end of the peg extends through the aperture in the component compartment bonnet. A coil spring surrounds the peg in the component compartment. The coil spring is contiguous with a spring base of the peg and the component compartment bonnet. The coil spring urges the seat cup against the sealing seat thus halting the flow of the liquid through the dispenser valve when the dispenser valve is inactive. A valve activation lever is attached to the slotted end of the peg. When the valve activation lever is activated it pulls the peg further through the component compartment bonnet, compresses the coil spring, pulls the seat cup away from the sealing seat, and enables the liquid to flow through the dispenser valve. A vent tube in valve body begins at a vent tube inlet port in the valve body, the vent tube having a barbed vent tube port that couples to a tube, the tube coupled to a check valve. A union threadably secures the threaded inlet port top to the mouth of the inverted supply bottle.

In accordance with one embodiment, a dispenser for delivering a liquid from a supply bottle is disclosed. The dispenser has a walled base having a hollow interior and a plastic rim. A removable bottle collar engages with the plastic rim and is adapted to engage and support the supply bottle inverted and positioned within the rim. The removable bottle collar has a center aperture where a mouth of the supply bottle extends there through. A top enclosure of the bottle collar is formed to engage the supply bottle. The top enclosure surrounds a portion of a sidewall of a body of the supply bottle. The top enclosure restricts a lateral movement of the supply bottle inverted and positioned within the top enclosure. A bottle seat of the bottle collar merges with the top enclosure. The bottle seat is formed to removably engage the supply bottle. The bottle seat has the center aperture where the mouth of the supply bottle extends through when the supply bottle is inverted and positioned on the bottle seat. An outer portion of the bottle collar merges with the bottle seat. The outer portion of the bottle collar is formed to removably engage upon the rim. A bottom ring merges with the outer portion of the bottle collar. The bottom ring is formed to restrict a lateral movement of the bottle collar upon the rim.

### BRIEF DESCRIPTION OF THE DRAWINGS

In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a perspective side view of an exemplary water bottle dispenser in accordance with one aspect of the present application;

FIG. 2 is a perspective side view of an exemplary reservoir dispenser valve used with the exemplary water bottle dispenser in accordance with one aspect of the present application;

FIG. 2V is a perspective side view of an exemplary vented dispenser valve used with the exemplary water bottle dispenser in accordance with one aspect of the present application;

FIG. 3 is a perspective side view of the exemplary reservoir dispenser valve depicted in FIG. 2 coupled to a water bottle in accordance with one aspect of the present application;

FIG. 3V is a perspective side view of the exemplary vented dispenser valve depicted in FIG. 2V coupled to a water bottle in accordance with one aspect of the present application;

FIG. 4—is an exploded view of the exemplary reservoir dispenser valve coupled to a water bottle of FIG. 3 in accordance with one aspect of the present application;

FIG. 4V—is an exploded view of the exemplary vented dispenser valve coupled to a water bottle of FIG. 3V in accordance with one aspect of the present application;

FIG. 5 is a top view of the exemplary reservoir dispenser valve of FIG. 2 in accordance with one aspect of the present application;

FIG. 5V is a top view of the exemplary vented dispenser valve of FIG. 2V in accordance with one aspect of the present application;

FIG. 6 is a sectional view of the exemplary reservoir dispenser valve shown in FIG. 5 taken at the sectioning plane in the direction indicated by section lines 6-6 in accordance with one aspect of the present application;

FIG. 6V is a sectional view of the exemplary vented dispenser valve shown in FIG. 5V taken at the sectioning plane in the direction indicated by section lines 6V-6V in accordance with one aspect of the present application;

FIG. 7 is a broken orthogonal side view of the exemplary reservoir dispenser valve of FIG. 2 in accordance with one aspect of the present application;

FIG. 7V is a broken orthogonal side view of the exemplary vented dispenser valve of FIG. 2V in accordance with one aspect of the present application;

FIG. 8 is a broken orthogonal side view of the exemplary reservoir dispenser valve of FIG. 2 in accordance with one aspect of the present application;

FIG. 8V is a broken orthogonal side view of the exemplary vented dispenser valve of FIG. 2V in accordance with one aspect of the present application;

FIG. 9 is broken orthogonal side view illustrating the exemplary reservoir dispenser valve of FIG. 2 and the exemplary of vented dispenser valve FIG. 2V in accordance with one aspect of the present application;

FIG. 10 is a sectional view of FIG. 9 taken at the sectioning plane in the direction indicated by section lines 10-10 in accordance with one aspect of the present application;

FIG. 11 is a perspective view of an exemplary bottle union used with the exemplary water bottle dispenser in accordance with one aspect of the present application;

FIG. 12 is a perspective view of an exemplary bottle union used with the exemplary water bottle dispenser in accordance with one aspect of the present application;

FIG. 13 is a perspective view of an exemplary bottle union used with the exemplary water bottle dispenser in accordance with one aspect of the present application;

FIG. 14 is a perspective view of an exemplary bottle union used with the exemplary water bottle dispenser in accordance with one aspect of the present application;

FIG. 15 is a perspective view of a backside of an exemplary base fitted with a bottle collar used with the exemplary water bottle dispenser in accordance with one aspect of the present application;

FIG. 16 is an exploded view of FIG. 15 in accordance with one aspect of the present application;

FIG. 17 is a perspective view of the backside of the exemplary water bottle dispenser in accordance with one aspect of the present application;

FIG. 18 is a perspective view of the front side of the exemplary water bottle dispenser in accordance with one aspect of the present application;

FIG. 19 is a perspective view of an exemplary retaining device assembly used with the exemplary water bottle dispenser in accordance with one aspect of the present application;

FIG. 20 is a perspective exploded view of the exemplary retaining device assembly of FIG. 19 in accordance with one aspect of the present application;

FIG. 21 is an orthogonal top view of the exemplary water bottle dispenser, with an exemplary front plate partially entered into a base wall in accordance with one aspect of the present application;

FIG. 22 is an orthogonal top view of the exemplary water bottle dispenser in accordance with one aspect of the present application;

FIG. 23 is a sectional view of the exemplary water bottle dispenser of FIG. 21, taken at the sectioning plane in the direction indicated by section lines 23-23 in accordance with one aspect of the present application;

FIG. 24 is sectional view of the exemplary water bottle dispenser of FIG. 22, taken at the sectioning plane in the direction indicated by section lines 24-24 in accordance with one aspect of the present application;

FIG. 25 is a perspective view of the rounded rectangular bottle collar used with the exemplary water bottle dispenser in accordance with one aspect of the present application;

FIG. 26 is an orthogonal top view of the exemplary water bottle dispenser fitted with an exemplary bottle collar in accordance with one aspect of the present application;

FIG. 27 is a sectional view of the exemplary water bottle dispenser of FIG. 26 taken at the sectioning plane in the direction indicated by section lines 27-27 in accordance with one aspect of the present application;

FIG. 28 is the same sectional view of FIG. 27 with a bottle resting inside of the exemplary bottle collar and base in accordance with one aspect of the present application;

FIG. 29 is a broken exploded perspective view of the sectional view shown in FIG. 28 in accordance with one aspect of the present application;

FIG. 30 is a perspective front view of the exemplary water bottle dispenser in accordance with one aspect of the present application.

### DETAILED DESCRIPTION OF THE DISCLOSURE

The description set forth below in connection with the appended drawings is intended as a description of presently preferred embodiments of the disclosure and is not intended to represent the forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that also are intended to be encompassed within the spirit and scope of this disclosure.

Accordingly, there are one or more aspects to the present water bottle dispenser that offers advantages over the current existing methods that are being used to serve people water. Embodiments of the disclosure provide a water bottle dispenser that may allow water to be accessed directly from single use water bottles for use with the water bottle dispenser, with no transfer of water to a container required. In accordance with one embodiment, the water bottle dispenser may reduce the problem of not having a tool to administer a vent hole in the inverted supply bottle. The bottle dispenser may provide a piercing tool located in a threaded cylinder attached to the bottle dispenser. The piercing tool may quickly be accessed to administer a vent hole the supply bottle. Once a vent hole is administered in the supply bottle, the piercing tool may be placed back in the threaded cylinder where it stored, so that it is available for use to vent the next supply bottle that may be used with the water bottle dispenser. A bottle cap of the supply bottle may be threadably secured to the threaded cylinder. Thus the threaded cylinder may serve as a retainer for the bottle cap of the supply bottle that is used with the water bottle dispenser, which may prevent the bottle cap from being lost.

In accordance with one embodiment, the dispenser may provide a removable dispenser valve. The dispenser valve may be threadably secured to an upright supply bottle. The installation of the dispenser valve onto the upright supply bottle may be easy as only the valve is required to be coupled to the supply bottle. The dispenser valve may control the flow of water for the supply bottle. In accordance with one embodiment, the dispenser valve may have a reservoir in a valve body of the dispenser valve, that may store a predetermined quantity of water transferred from the supply bottle to coupled to the dispenser valve. The transfer of water may drop the water level in the supply bottle to a predetermined level. The dropped water level may allow for a vent hole to be administered in the supply bottle without water escaping out of the vent hole. In accordance with one embodiment, the dispenser valve may be a vented dispenser valve, and may have a vent tube in a valve body of the dispenser valve, and the tube may begin at a vent tube inlet port in the valve body. The vent tube of the dispenser valve may have a barbed vent tube port that may couple to a tube, and the tube may couple to a check valve. The vented dispenser valve generally does not require a vent hole to be formed in the supply bottle, and may allow for the inverted supply bottle to be turned up upright and placed in a refrigerator if needed.

Lastly, the dispenser valve may be an improvement over the “one-off” dispenser valves that are commonly used with countertop dispensers, so the quality and life of the dispenser valve may be better, and the dispenser valve may be less likely to leak. The above advantages of one or more aspects of the water bottle dispenser will become apparent upon reflection of the disclosure set forth below.

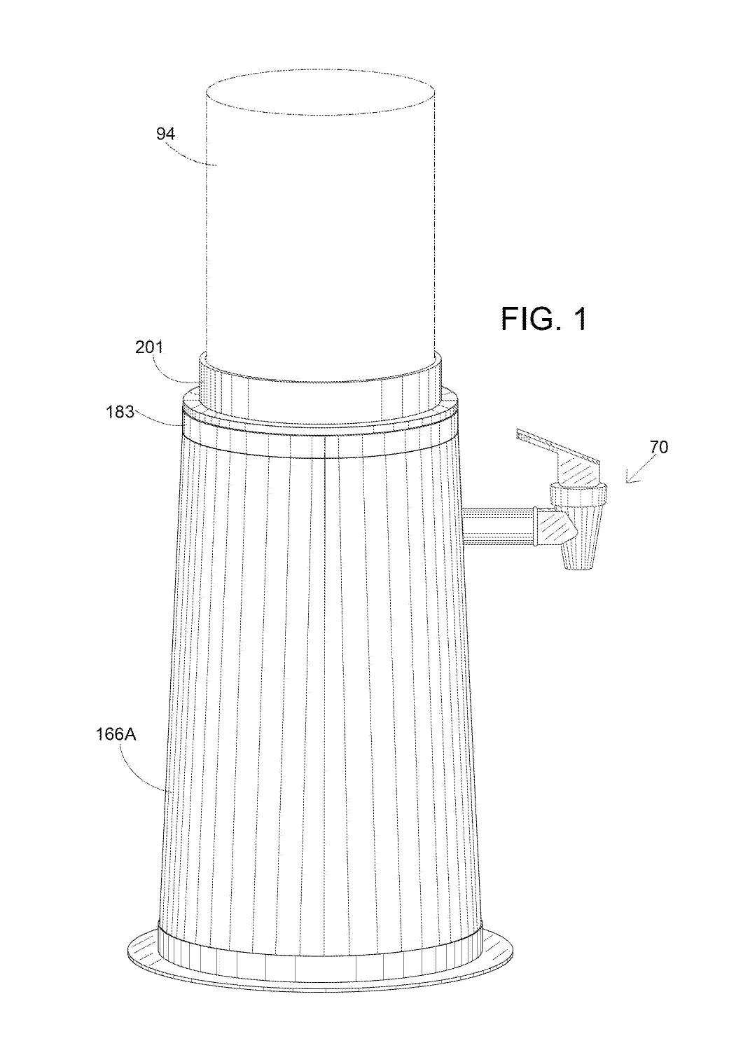

Referring to FIG. 1 a perspective side view of a water bottle dispenser (hereinafter dispenser) is shown. The dispenser may have a base 166A. In the present embodiment, the base 166A may be cylindrical in shape. However, only one example is illustrated, and the base 166A may be offered in a number of other geometrical shapes and sizes. As shown in FIG. 1, the base 166A may be tapered. Thus, a bottom portion of the base 166A may be wider than an upper portion of the base 166A. The tapered nature of the base 166A may provide added stability, and may allow for the base 166A to be stacked. The base 166A may be formed to have a hollow interior. The base 166A may have a removable bottle collar 201 (hereinafter bottle collar 201). The base 166A and the bottle collar 201 may be constructed of a durable plastic such as polypropylene or of a metal such as stainless steel. The bottle collar 201 may be removably engaged upon a circular rim 183 formed on a top portion of base 166A. The bottle collar 201 may be used to support an inverted circular supply bottle 94 upon the base 166A. A dispenser valve 70 may be coupled to the supply bottle 94. The dispenser valve 70 may be used to dispense water (hereinafter liquid) from the supply bottle 94.

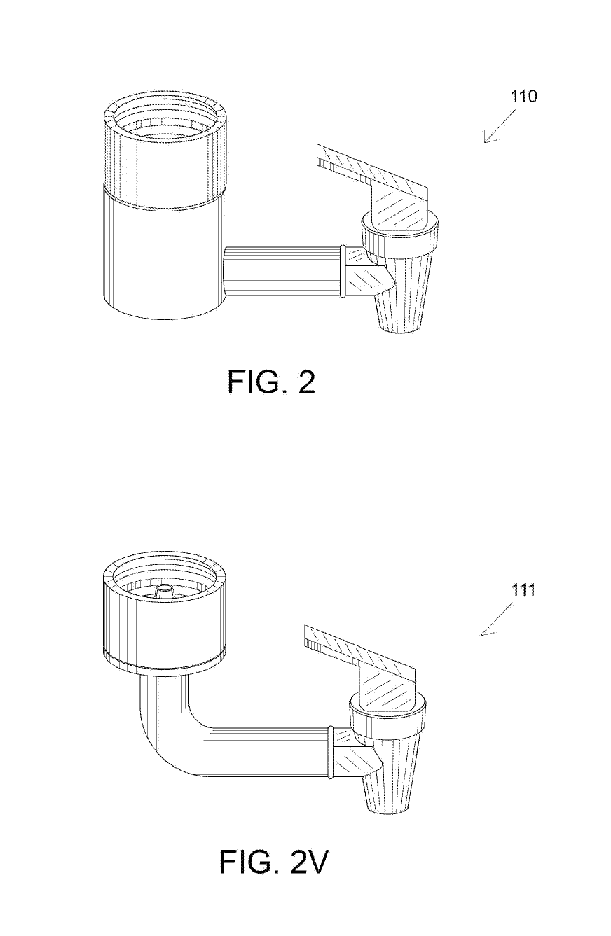

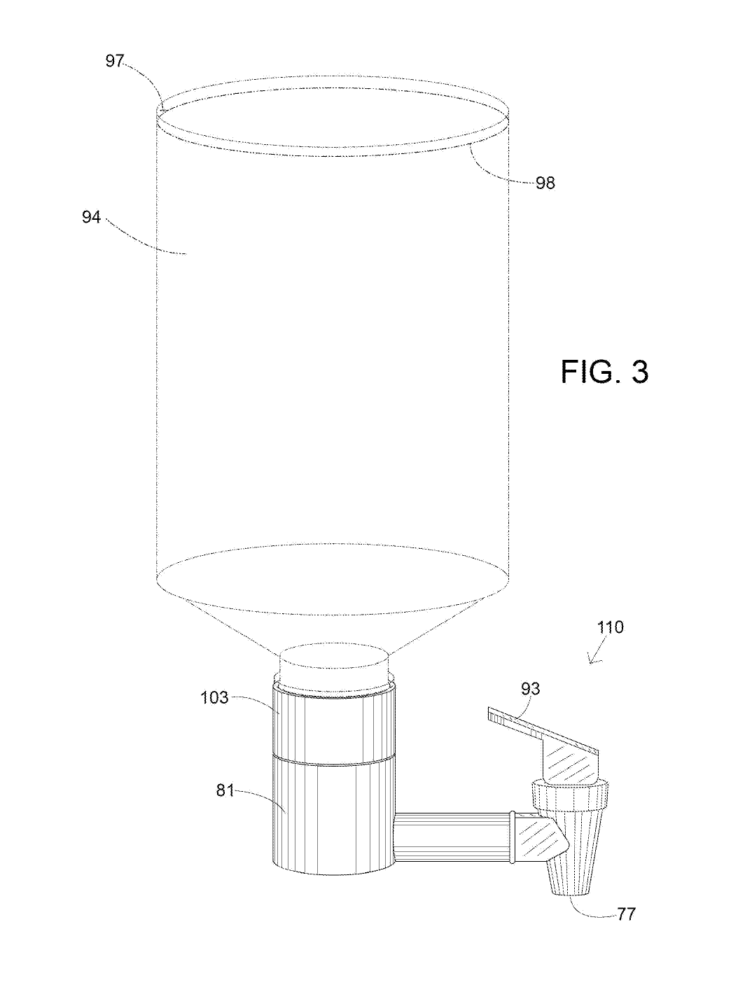

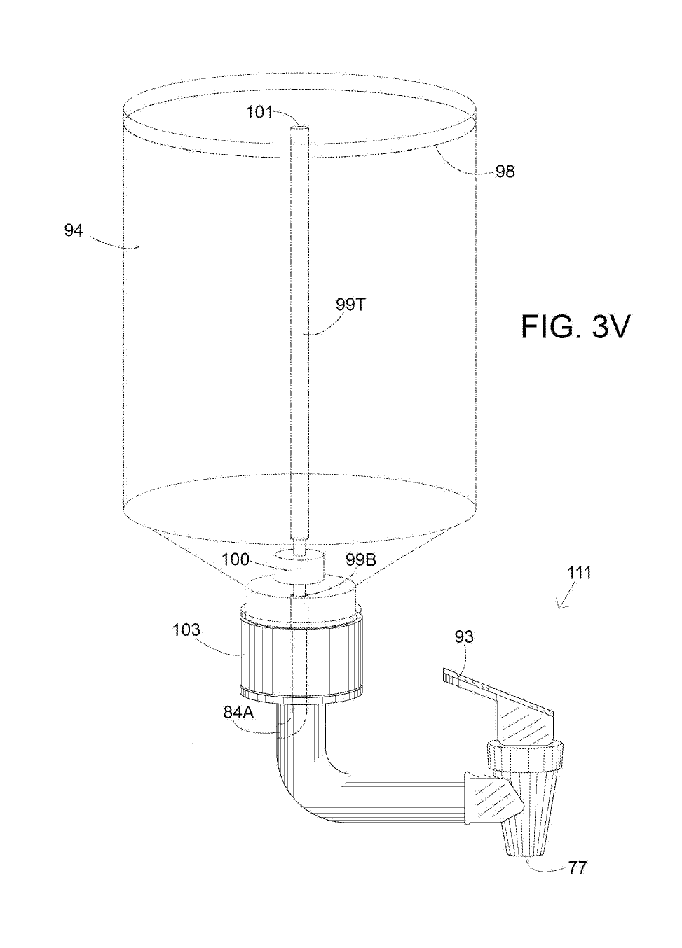

Referring to FIGS. 2 and 3, the dispenser valve 70 of FIG. 1 may be a reservoir dispenser valve 110 (hereinafter dispenser valve 110). In accordance with one embodiment the dispenser valve 110 is a removable dispenser valve. As may be shown in FIG. 3, the dispenser valve 110 may be removably coupled to the supply bottle 94 with a bottle union 103. The dispenser valve 110 may control a flow of a liquid from the supply bottle 94. The dispenser valve 110 is generally not vented, and may require that prior to usage, a vent hole 97 be administered to the supply bottle 94 in order for liquid to flow adequately through dispenser valve 110 and out of a valve body outlet port 77 when a valve activation lever 93 is activated. The dispenser valve 110 may contain the reservoir 81. The reservoir 81 may allow for the transfer of a predetermined amount of liquid from the supply bottle 94 into the reservoir 81. This transfer of liquid may drop a liquid level 98 in the supply bottle 94 to a predetermined level. The dropped liquid level may allow for the vent hole 97 to be administered to the supply bottle 94 without the liquid in the supply bottle 94 escaping through vent hole 97.

Referring to FIGS. 2V and 3V, the dispenser valve 70 of FIG. 1 may be a vented dispenser valve 111 (hereinafter dispenser valve 111). In accordance with one embodiment, the dispenser valve 111 is a removable dispenser valve. As may be shown in FIG. 3V, the dispenser valve 111 may be removably coupled to supply bottle 94 with bottle union 103. The dispenser valve 111 may control the flow of the liquid from the supply bottle 94. The dispenser valve 111 may be used with a check valve 100. When using the dispenser valve 111, a vent hole may not be required in supply bottle 94. Air may enter the dispenser valve 111 through a vent tube inlet port 84A. The air may then enter a bottom tube 99B and flow through check valve 100, and exit a top tube 99T into the supply bottle 94 through a tube inlet 101. The check valve 100 may function quietly as long as the liquid level 98 of the supply bottle 94 is below the tube inlet 101 of the top tube 99T as this may prevent liquid from entering the check valve 100. It should be noted that the dispenser valve 111 might operate without the tube 99T. However, if the tube 99T is used, the dispenser valve 111 may operate in a quieter manner. When a valve activation lever 93 is activated, liquid may flow through the dispenser valve 111 and exit at valve body outlet port 77. Any bottle used with the dispenser valve 111 may be removed from the dispenser at any time, turned upright, and placed back in a refrigerator if needed.

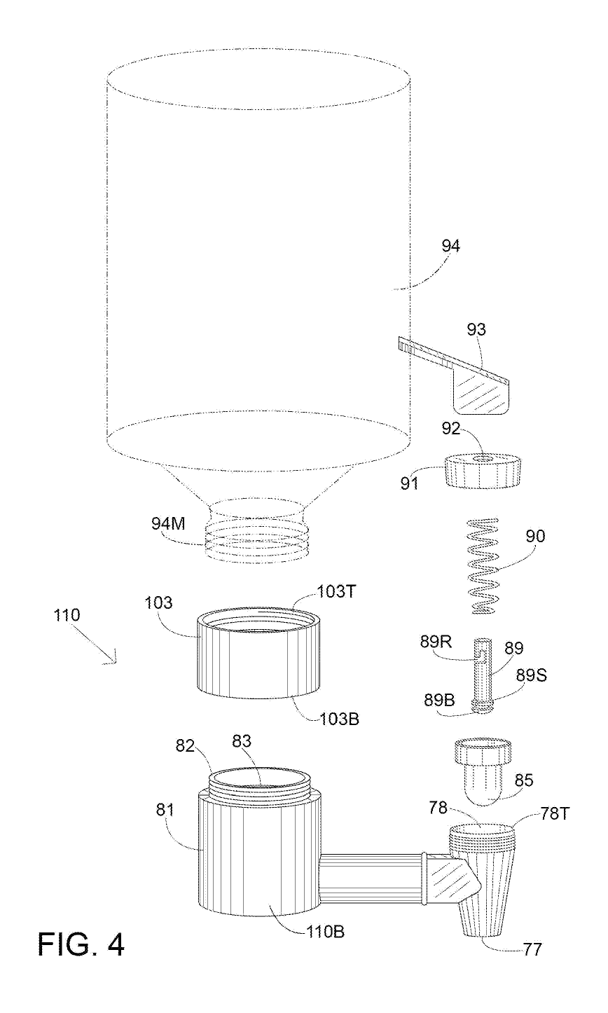

Referring to FIG. 4, and an exploded view of FIG. 3 may be seen. In FIG. 4, the supply bottle 94 and the dispenser valve 110 are illustrated. A union bottom 103B of the bottle union 103 may be threadably secured to a valve body inlet port top 82, and a bottle mouth 94M of the supply bottle 94 may be threadably secured to a bottle union top 103T of bottle union 103. A valve body inlet port 83, a reservoir 81, and a valve body outlet port 77 of a valve body 110B may be in liquid communication with one another. The valve body 110B of dispenser valve 110 may be formed to deliver the liquid from supply bottle 94 to location to a side of the mouth 94M of the supply bottle 94. A component compartment 78, a rubber seat cup 85, and a peg base 89B of a peg 89 may be seen. The peg base 89B may anchor into the seat cup 85. A spring base 89S is where a coil spring 90 may rest when the dispenser valve 110 is assembled. A right pin slot 89R of peg 89 may be seen. The peg 89 may fit inside of the coiled spring 90. A peg aperture 92 of a component compartment bonnet 91 may be seen. Component compartment bonnet 91 may force up against the coil spring 90 when dispenser valve 110 is fully assembled. The peg aperture 92 of component compartment bonnet 91 may be where peg 89 passes through component compartment bonnet 91 so that peg 89 can attach to valve activation lever 93. Component compartment bonnet 91 may be threadably secured onto a threaded component compartment top 78T.

Referring to FIG. 4V, an exploded view of FIG. 3V may be seen. In FIG. 4V, the supply bottle 94 and the dispenser valve 111 may be seen. The union bottom 103B of the bottle union 103 may be threadably secured to the valve body inlet port top 82, and the bottle mouth 94M of the supply bottle 94 may be threadably secured to the union top 103T of the bottle union 103. The valve body inlet port 83 and valve body outlet port 77 may be in liquid communication with a valve body 111B. The valve body 111B of dispenser valve 111 may be formed to deliver the liquid from supply bottle 94 to location to a side of the mouth 94M of the supply bottle 94. A vent tube inlet port 84A may be where air enters the valve body 111B, flows through the vent tube 84, and exits at a barbed vent tube port 84B. The barbed vent tube port 84B may couple to a tube 99B, and the tube 99B may couple to the check valve 100 at a bottom barbed inlet 100B. The tube 99T may couple to the check valve 100 at a top barbed inlet 100T. When the dispenser valve 111 is fully assembled and coupled to supply bottle 94, air may enter the dispenser valve 111 at the vent tube inlet port 84A, and air may exit tube 99T at the tube outlet 101, which may allow air to enter the supply bottle 94, and liquid may freely from the valve body outlet port 77 when the valve activation lever 93 is activated. To the right of the valve body 111B may be the component compartment 78, and the threaded component compartment top 78T. Located above the component compartment 78 may be a seat cup 85, and a peg base 89B of the peg 89. The peg 89 may be anchored into the seat cup port 85. The coil spring 90 may surround the peg 89 and may sit on the spring base 89S of the peg 89 when the dispenser valve 111 is assembled. A right pin slot 89R of the peg 89 may be seen. The peg aperture 92 of the component compartment bonnet 91 may also be seen. The component compartment bonnet 91 may force up against the coil spring 90 when the dispenser valve 111 is fully assembled. The peg aperture 92 of the component compartment bonnet 91 may be where the peg 89 passes through the component compartment bonnet 91 so that the peg 89 may attach to the valve activation lever 93. The component compartment bonnet 91 may be threadably secured to the component compartment top 78T.

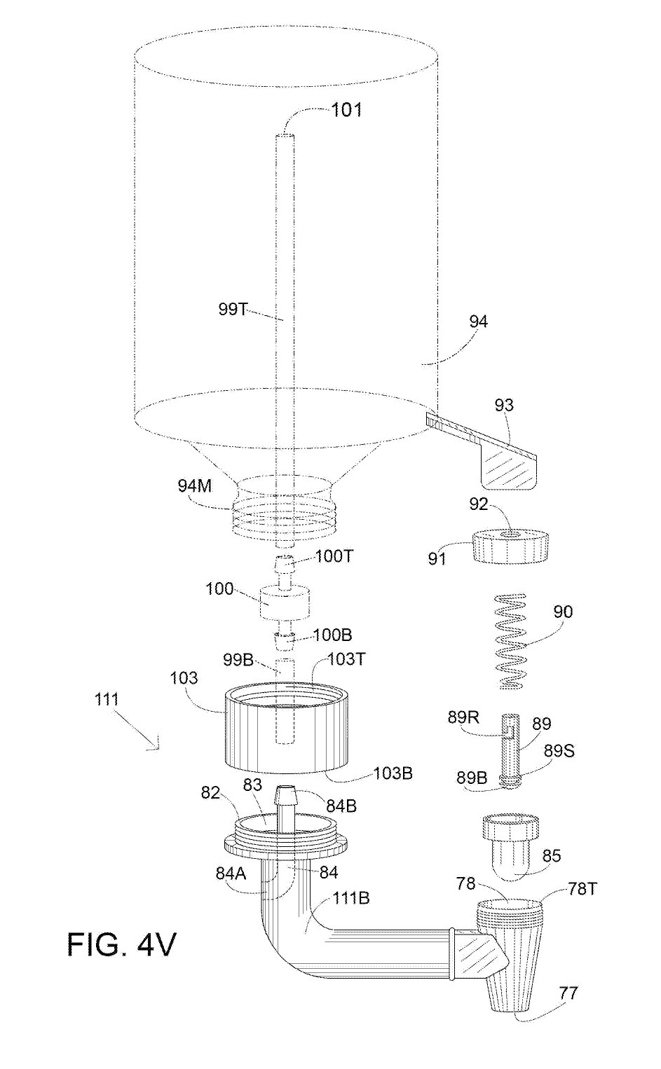

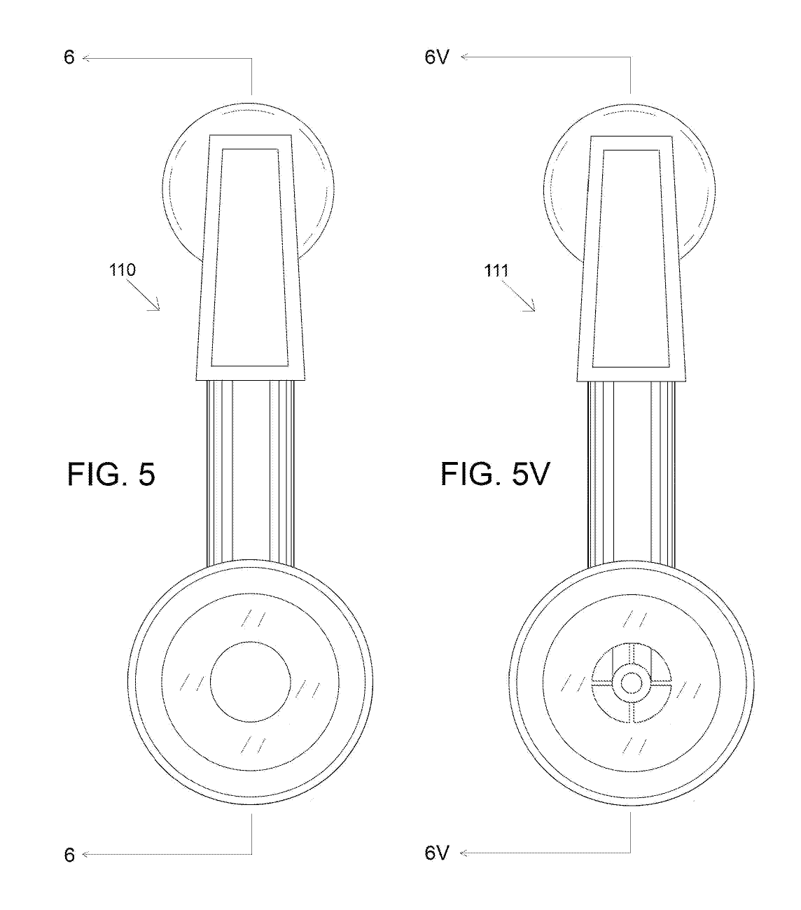

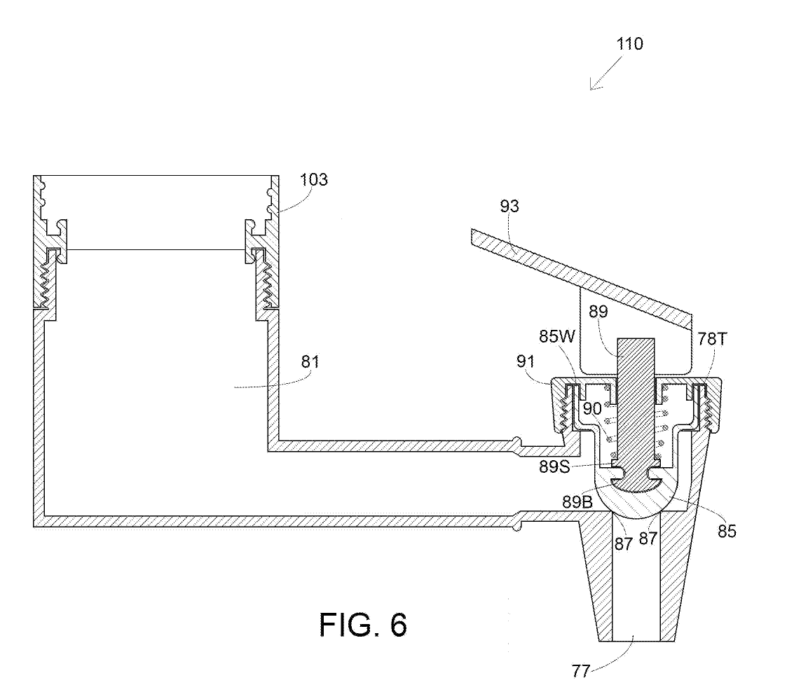

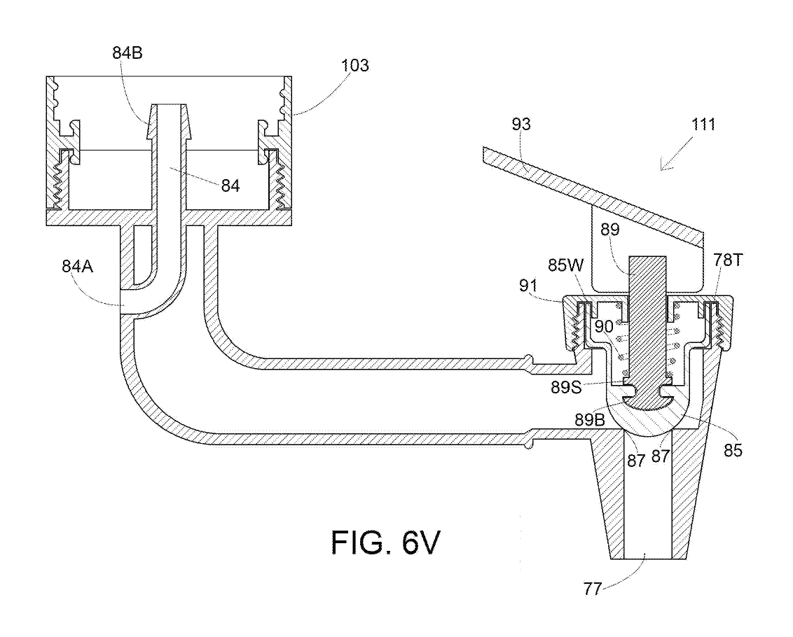

Referring to FIGS. 5 and 6, wherein FIG. 5 is an orthogonal top view of the dispenser valve 110 of FIG. 2 and FIG. 6 is sectional view taken along section lines 6-6 of FIG. 5, the bottle union 103 may be attached to the dispenser valve 110. The valve activation lever 93 may move the peg base 89B, which moves the seat cup 85 upward by pulling the peg 89 further to the outside of the component compartment bonnet 91 when the valve activation lever 93 is activated. The coil spring 90 may rest on the spring base 89S of the peg 89, and push up against the component compartment bonnet 91 which may urge the seat cup 85 downward against a sealing seat 87 when the valve activation lever 93 is in a resting position as may be seen. The sealing seat 87 may be in liquid communication with the valve body inlet port 83, and the valve body outlet port 77. The component compartment bonnet 91 may be contiguous with the seat cup wall 85W to prevent any liquid leakage, and may be threadably secured onto the component compartment top 78T. The valve reservoir 81 and the valve body outlet port 77 as discussed above may also be seen.

Referring to FIGS. 5V and 6V, wherein FIG. 5V is an orthogonal top view of the valve 111 of FIG. 2V and FIG. 6V is sectional view taken along section lines 6V-6V of FIG. 5V, the bottle union 103 may be attached to the dispenser valve 111. Air may enter the vent tube 84 that begins at vent tube inlet port 84A, travel through the vent tube 84, and exit the barbed vent tube outlet port 84B. The valve activation lever 93 may move the peg base 89B when the valve activation lever 93 is activated. The peg base 89B may move the seat cup 85 upward by pulling the peg 89 further to the outside of component compartment bonnet 91. The coil spring 90 may rest on the spring base 89S of the peg 89, and push up against the component compartment bonnet 91, which may urge the seat cup 85 downward against the sealing seat 87 when the valve activation lever 93 is in the resting position as may be seen. The sealing seat 87 may be in liquid communication with the valve body inlet port 83, and the valve body outlet port 77. The component compartment bonnet 91 may be contiguous with a seat cup wall 85W, and threadably secured onto the component compartment top 78T. Liquid may exit the dispenser valve 111 at valve body outlet port 77.

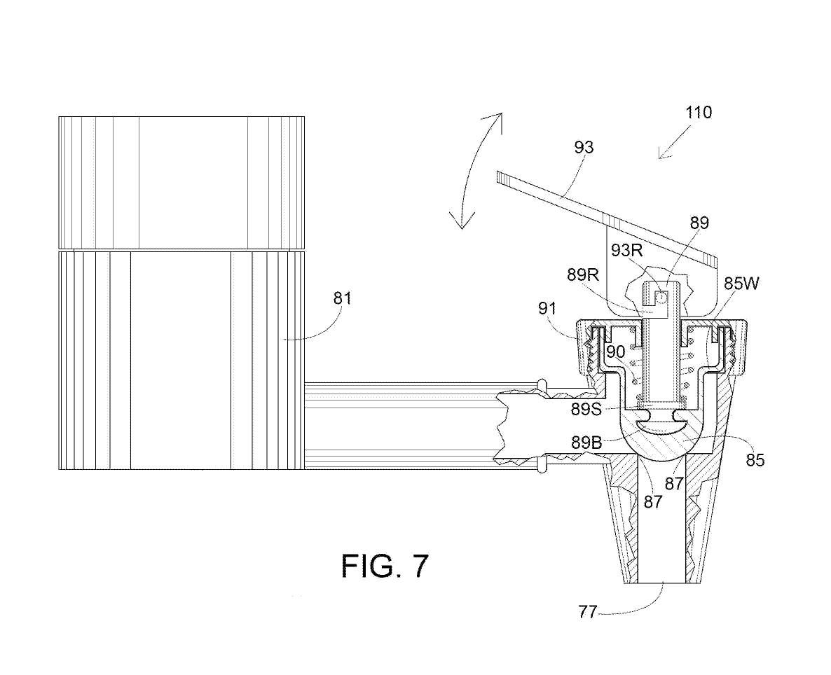

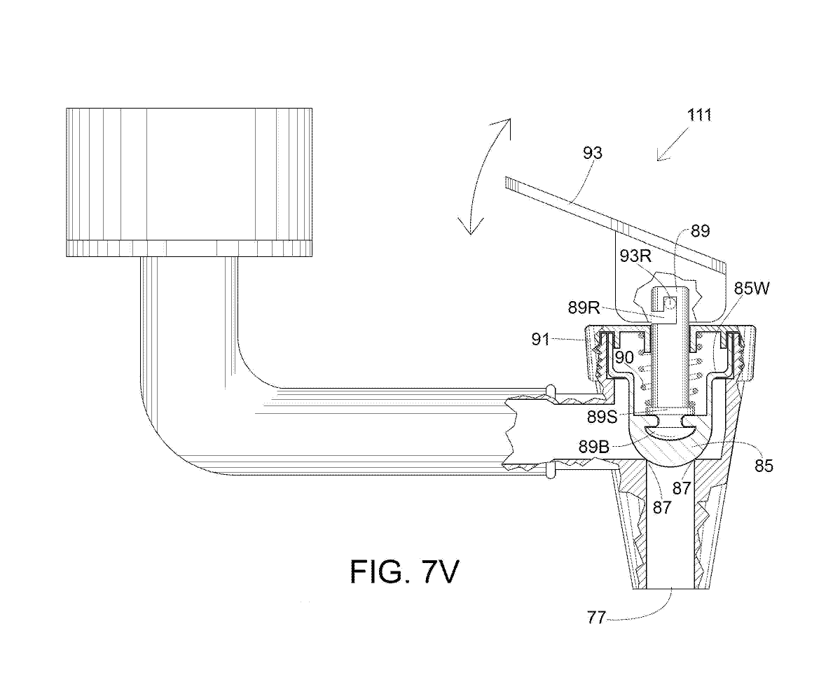

Referring to FIG. 7, the valve activation lever 93 of the dispenser valve 110 may be depicted in a resting position. When the valve activation lever 93 is resting, the seat cup 85 may be urged against the sealing seat 87, which may halt the flow of liquid from the reservoir 81 from making its way through the valve body outlet port 77. The coil spring 90 may push up against the component compartment bonnet 91 and the spring base 89S of the peg 89. With the seat cup 85 attached to the peg base 89B, the seat cup 85 may be urged against sealing seat 87 which may halt the flow of liquid through the dispenser valve 110. Thus seat cup wall 85W may be in a straight position. The right pin slot 89R can be where a right pin 93R of the valve activation lever 93 engages with the peg 89.

Referring to FIG. 7V, the workings of dispenser valve 111 may be similar to that of the dispenser valve 110 disclosed above with reference to FIG. 7 when the dispenser valve 111 is in resting position. As with the dispenser valve 110, when the valve activation lever 93 is resting, the seat cup 85 may be urged against the sealing seat 87, which may halt the liquid from making its way through the valve body outlet port 77. Thus the seat cup wall 85W is in a straight position. The coil spring 90 may push against the component compartment bonnet 91 and the spring base 89S of the peg 89, and with the seat cup 85 attached to the peg base 89B, the seat cup 85 may be urged against the sealing seat 87 which may halt the liquid from flowing through the dispenser valve 111. The right pin slot 89R may be where the right pin 93R of valve activation lever 93 engages with the peg 89.

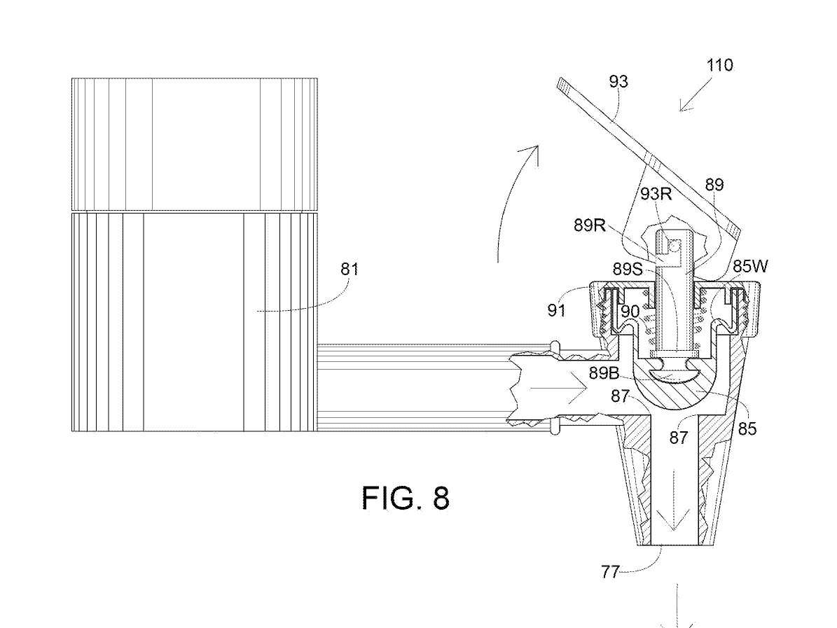

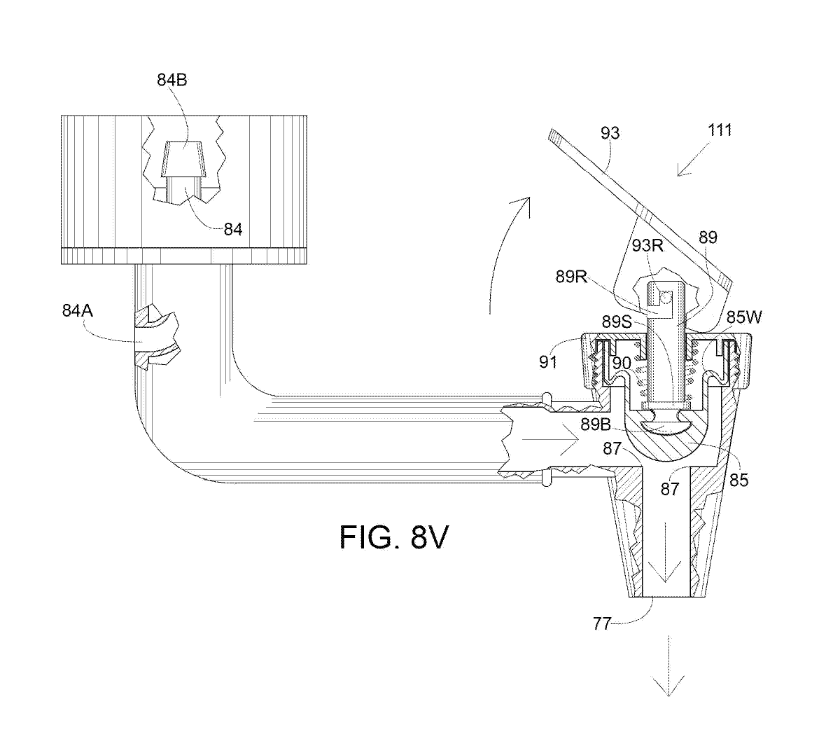

Referring to FIG. 8, the valve activation lever 93 of the dispenser valve 110 may be moved forward. When the valve activation lever 93 is moved forward, the right pin 93R and a left pin 93L (see FIG. 10), of the valve activation lever 93, that are inserted into the right pin slot 89R and a left pin slot 89L (see FIG. 10) of peg 89, may pull the peg base 89B of the peg 89 upward. When the peg 89 moves upward, it may pull the seat cup 85 away from the sealing seat 87 by compressing the coil spring 90 up against the coiled spring base 89S of the peg 89 and the component compartment bonnet 91. The liquid may then flow through the dispenser valve 110 from the reservoir 81 and may pass through the valve body outlet port 77. Thus, the seat cup wall 85W may be in a flexed position.

Referring to FIG. 8V, the valve activation lever 93 of the dispenser valve 111 may be seen moved forward. The operation is similar to the operation disclosed in FIG. 8. However, in this embodiment, the vent tube 84 may pull air into the supply bottle (not shown) that is in union with the dispenser valve 111. When the valve activation lever 93 is moved forward, the right and left pins 93R and 93L (see FIG. 10) of the valve activation lever 93, that are inserted into the right and left pin slots 89R and 89L (see FIG. 10) of peg 89, may pull the peg base 89B of the peg 89 upward. When the peg 89 moves upward, it may pull the seat cup 85 away from sealing seat 87 by compressing the coil spring 90 up against the peg coiled spring base 89S and the component compartment bonnet 91. Air may then flow into the vent tube inlet port 84A and through the barbed vent tube port 84B. When in use, the liquid may then flow through the dispenser valve 111 and pass through the valve body outlet port 77. Thus, the seat cup wall 85W may be in a flexed position.

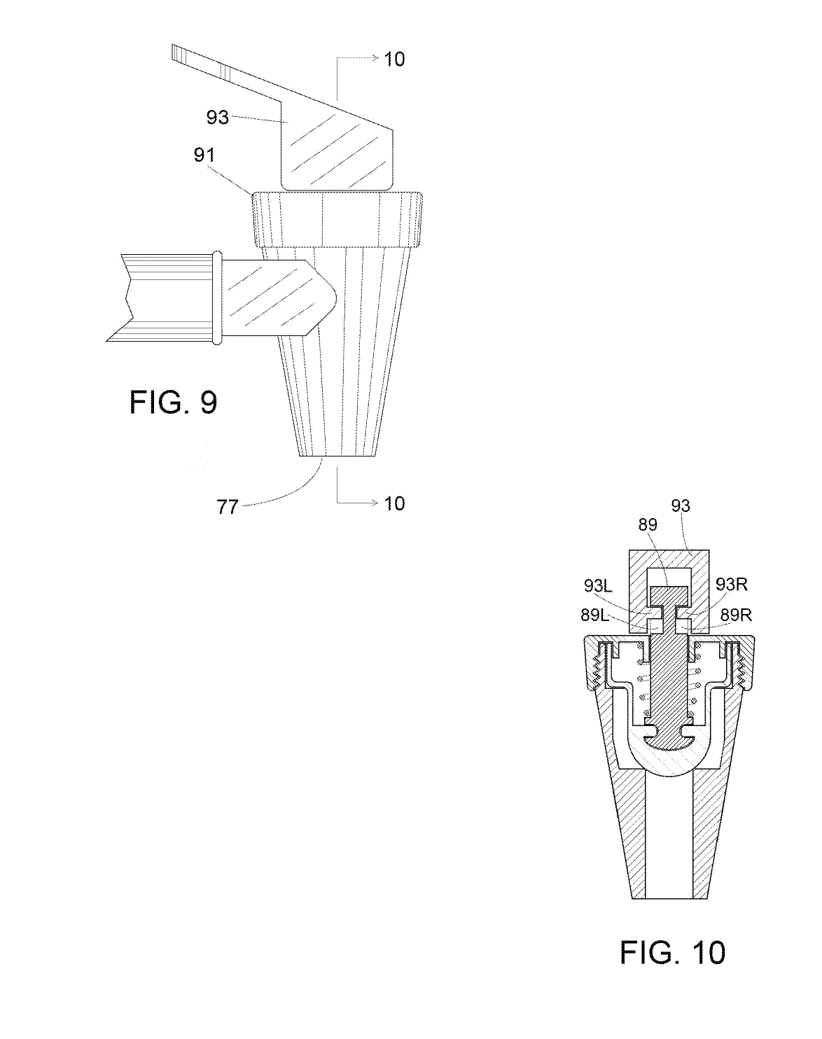

Referring to FIG. 10, which is a sectional view of FIG. 9 taken at the sectioning plane in the direction indicated by section lines 10-10, the component compartment bonnet 91, the valve activation lever 93, and the valve body outlet port 77 of the dispenser, valves depicted in FIGS. 2 and 2V may be shown. In the FIG. 10, the right and left pins 93R and 93L of the valve activation lever 93 may be seen along with the right and left pin slots 89R and 89L of the peg 89, showing how the valve activation lever 93 may engage the peg 89 and may activate the dispenser valve in FIG. 9.

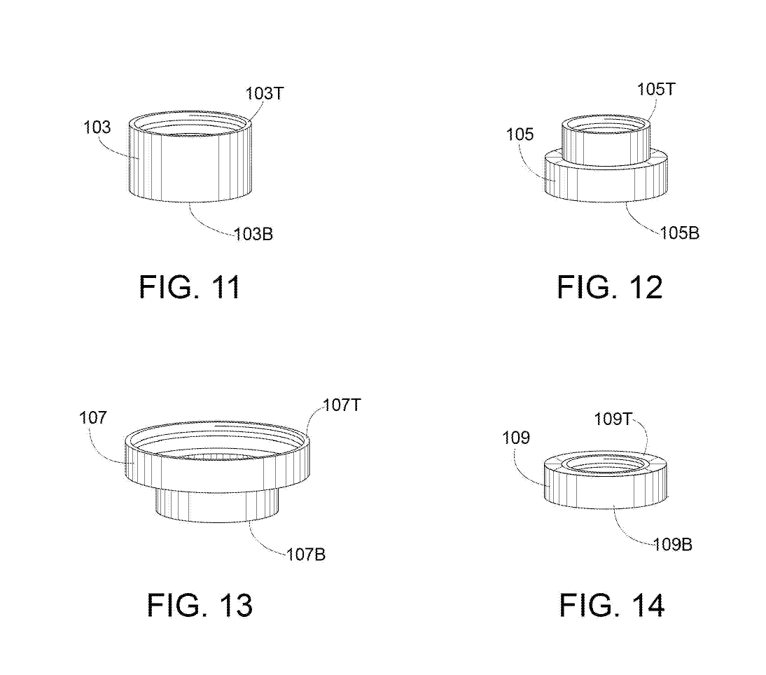

Referring to FIG. 11, a perspective view of the bottle union 103 may be seen. The bottle union 103 has a union bottom 103B that couples to the dispenser valve 110 and/or dispenser valve 111 of FIGS. 4 and 4V. Threads may be formed within an interior perimeter of the bottle union 103. The threads may be used to engage threads formed on the dispenser valve 110 and dispenser valve 111 of FIGS. 4 and 4V respectively. A top 103T of the bottle union 103 may be configured so that the threads formed in the interior of the bottle union 103 engage with threads formed on a mouth of the supply bottle 94.

FIG. 12 illustrates a perspective view of another embodiment of a bottle union, bottle union 105. The same functionality of bottle union 103 may apply to bottle union 105. However, in the embodiment of FIG. 12, a top diameter of a union top 105T may be smaller than a bottom diameter of a union bottom 105B. The union top 105T may be configured to fit the threaded mouth of the supply bottle 94 in which the diameter of the specific bottle mouth is smaller than the union bottom 105B that engages with the dispenser valve 110 and/or dispenser valve 111 of FIGS. 4 and 4V respectively.

FIG. 13 illustrates a perspective view of another embodiment of a bottle union, bottle union 107. The same functionality of bottle unions 103 and/or 105 applies to the bottle union 107. However, in the embodiment of FIG. 13, a top diameter of a union top 107T is larger than a bottom diameter of a union bottom 105B. The union top 107T is configured to fit the threaded mouth of the supply bottle 94 in which the diameter of the specific bottle mouth is larger than the union bottom 107B that engages with dispenser valve 110 and/or dispenser valve 111 of FIGS. 4 and 4V respectively.

Another embodiment of a bottle union, bottle union 109 is illustrated in FIG. 14. The bottle union 109 may locate the threads of a union top 109T that couples to a bottle mouth 94M of FIGS. 4 and 4V within the diameter of the threads of a union bottom 109B that couples with the threads of the dispenser valve top 82 of dispenser valve 110 and/or dispenser valve 111 of FIGS. 4 and 4V respectively. The result would likely be a shorter, and more compact bottle union than the bottle union 105. However, if the bottle mouth 94M, and the threaded valve top 82 are of the same diameter as in FIGS. 4 and 4V, construction of the bottle union 109 may not be possible, and the bottle union 103 would probably be used. In addition, the bottle union 109 could also be used as a substitute for the bottle union 107 if flipped. If this were the case, the threaded valve top 82 may couple to the union top 109T and the bottle mouth 94M may couple to the union bottom 109B.

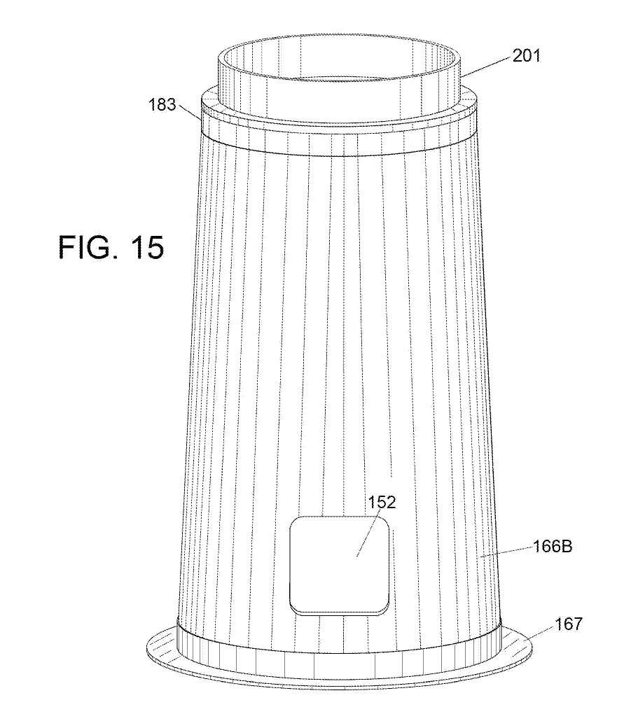

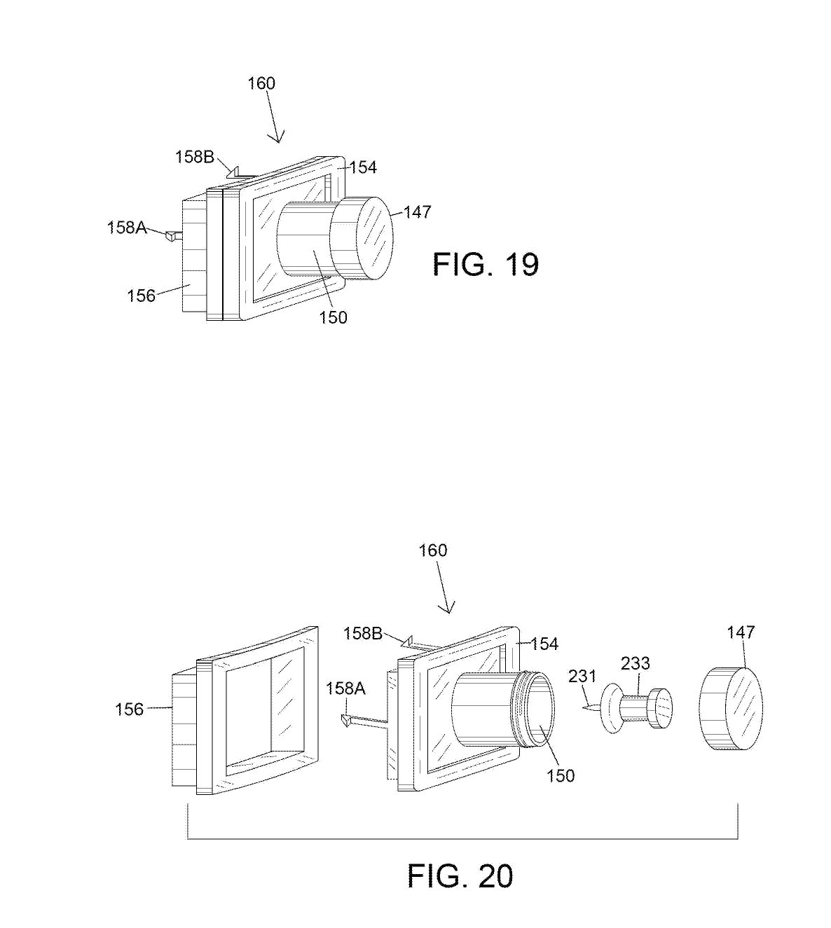

Referring to FIG. 15, a front view of the dispenser may be seen void of a retaining device assembly 160 (as shown in to FIGS. 19 and 20). A retaining device void 152 may be formed in a lower part of a base 166B. The retaining device void 152 may be where a retaining device assembly 160 of FIGS. 19, 20 may be attached to the base 166B. The bottle collar 201 may be removably engaged upon a base rim 183 formed in a top portion of base 166B. A base foot 167 may be formed in a bottom portion of base 166B and may extend horizontally therefrom. The base 166B and bottle collar 201 may be constructed of the durable plastic the polypropylene or of the metal stainless steel. The base 166B may be configured to be hollow. This may allow the base 166B to be nested (stacked) when void of the retaining device assembly 160.

In the present embodiment, the base 166B may be cylindrical in shape. However, this is shown as one example and the base 166B may come in other geometrical shapes and sizes. For example, the base 166B may be configured for placement on a counter top or configured for placement on a floor. As shown in FIG. 15, the base 166B may be tapered. Thus, a bottom portion of the base 166B may be wider than an upper portion of the base 166B. The tapered nature of the base 166B may provide added stability, and additionally may provide for base 166B to be stacked.

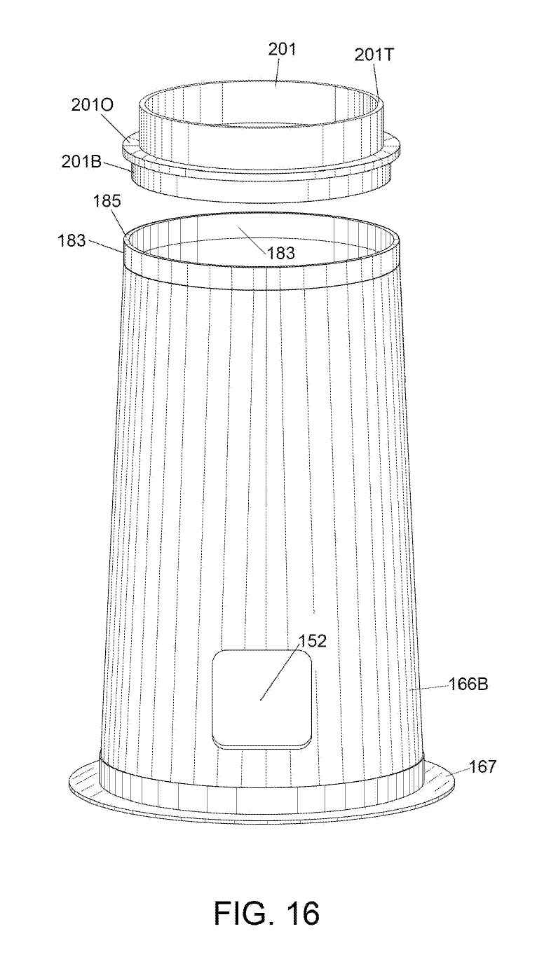

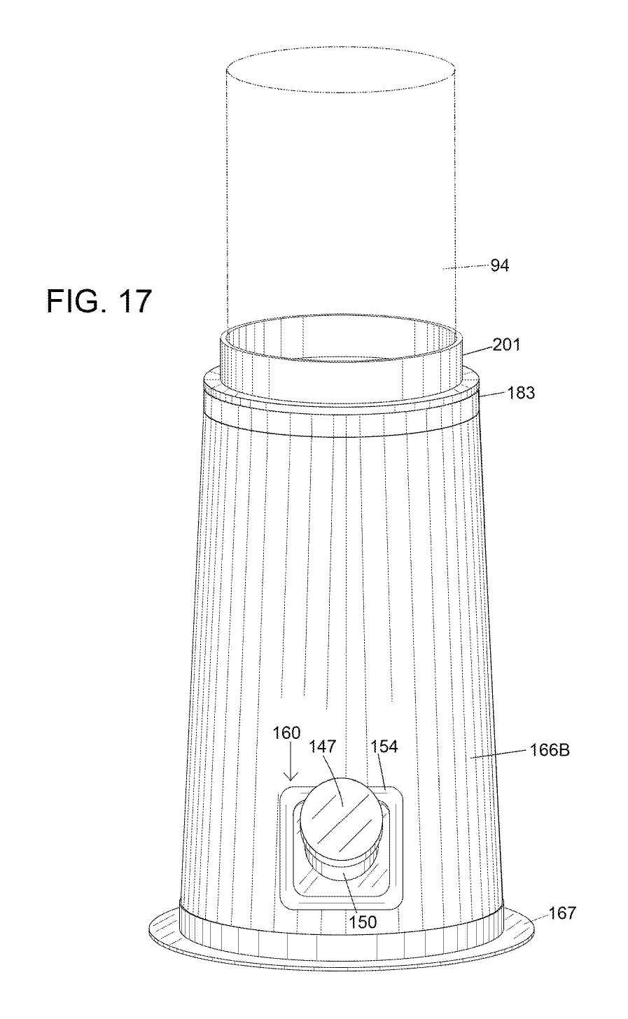

Referring to FIG. 16, an exploded view of FIG. 15 may be seen. A circular top enclosure 201T of bottle collar 201 may be formed to engage the circular body of the circular supply bottle 94 of FIG. 17. An outer portion 201O of bottle collar 201 may removably engage upon base rim top 185 of rim 183 to support bottle collar 201 upon rim 183. A bottom ring 201B may be positioned on the inside of rim 183, and may be formed to restrict a lateral movement of bottle collar 201 upon base top 185 of base rim 183. The bottom ring 201B could also be formed on the outside of rim 183 to restrict the lateral movement of bottle collar 201 upon rim 183. A base foot 167, and retaining device void 152 of base 166B may be seen.

Referring to FIG. 17, the backside of the dispenser 166B may be viewed with the retaining device 160 attached. The front plate 154 of the retaining device 160 may be seen covering the retaining device void 152 of FIG. 16. The bottle collar 201 may be seen removably engaged upon the rim 183 of base 166B. The bottle collar 201 may be adapted to engage and support the supply bottle 94 while the supply bottle 94 may be inverted and positioned within the rim 183. A bottle cap 147, which may have been removed from the supply bottle 94, may be threadably secured onto a threaded cylinder 150 of a front plate 154. The threaded cylinder 150 may be a retainer that may store and removably attach a piercing tool 233 (FIG. 20) to the base 166B. The threaded cylinder 150 may have external threads that may be configured to be approximately identical to the threads of the bottle mouth 94M (FIG. 4) of the supply bottle 94. The threads of the threaded cylinder 150 of the front plate 154 may be made to mate with the threads of the bottle cap 147 that may have been removed from the supply bottle 94 so that the bottle cap 147 may be threadably secured onto the threaded cylinder 150. The bottle cap 147 may be the cap that is part of the retaining device assembly 160, or may be the cap that was removed from supply bottle 94. Base foot 167 may also be seen in FIG. 17.

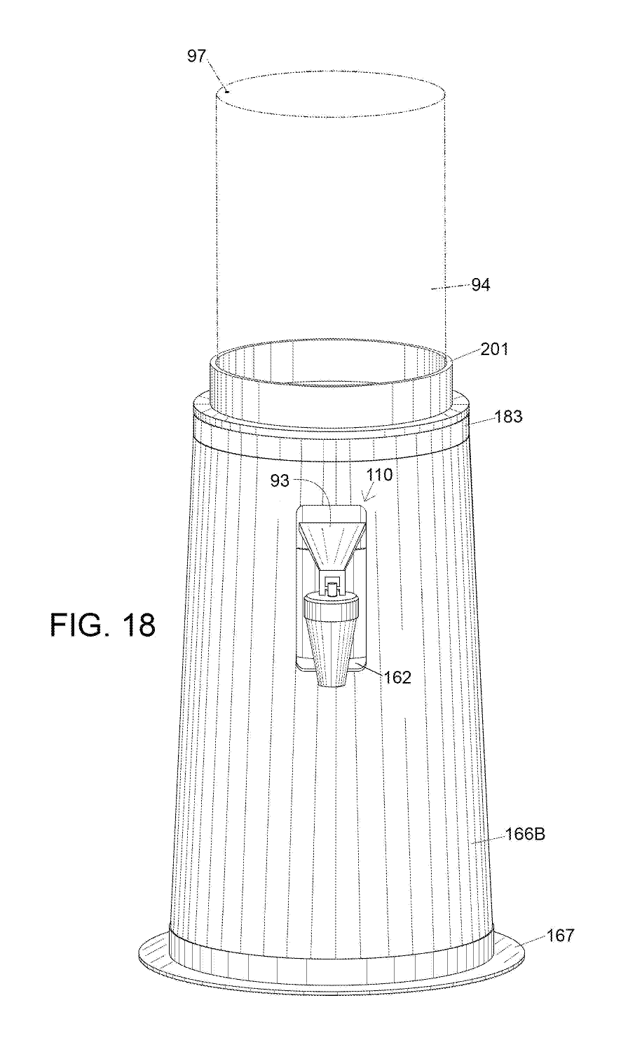

Referring to FIG. 18, a front view of the dispenser may be illustrated. The supply bottle 94 may be inverted and inserted into the bottle collar 201. The bottle collar 201 may be removably engaged upon the base rim 183. The supply bottle 94 may be inverted and positioned within rim 183 of the bottle collar 201. A vent hole 97 may be administered in the supply bottle 94 to accommodate the dispenser valve 110. The liquid from supply bottle 94 may be delivered from the mouth 94M (FIG. 4) of the supply bottle 94 through a window 162 formed a base 166B, and to a location outside of the base 166B when the valve activation lever 93 of the dispenser valve 110 is activated. In the present embodiment the dispenser valve 110 is illustrated. However, the dispenser valve 111 may be used also. The base foot 167 may also be seen in the present embodiment.

Referring to FIG. 19, the retaining device assembly 160 may be seen. The retaining device assembly 160 may be constructed of a durable plastic such as polypropylene or of a metal. The front plate 154 may engage with rear mounting plate 156, and the bottle cap 147 may be threadably secured onto the threaded cylinder 150. The threaded cylinder 150 may merge with front plate 154. A barbed fastening arm 158A and a barbed fastening arm 158B of the front plate 154 may be seen and may be described below.

Referring to FIG. 20, an exploded view of FIG. 19 may be seen. In the present embodiment, the rear mounting plate 156 may be separated from front plate 154. The threaded cylinder 150 may be where the retaining device 160 may removably attach a piercing tool 233 to the base 166B (FIG. 17). Threaded cylinder 150 may merge with the front plate 154. A bottle cap 147 may be separated from the threaded cylinder 150. A piercing tool 233 and a piercing tool spike 231 may also be seen. Fastening arms 158A and 158B of front plate 154 may be seen. While the present embodiment shows two fastening arms 158A and 158B, this is shown as an example and the front plate 154 may have additional fastening arms without departing from the spirit and scope of the present invention. The bottle cap 147 may be threadably secured to the threaded cylinder 150. The external threads of the threaded cylinder 150 of the front plate 154 may be designed to mate with the internal threads of the bottle cap 147 that was removed from the supply bottle 94 shown in FIG. 17 so that the bottle cap 147 may be threadably secured onto the threaded cylinder 150. The bottle cap 147 may be the bottle cap that is part of the retaining device assembly 160, or may be the cap that was removed from supply bottle 94.

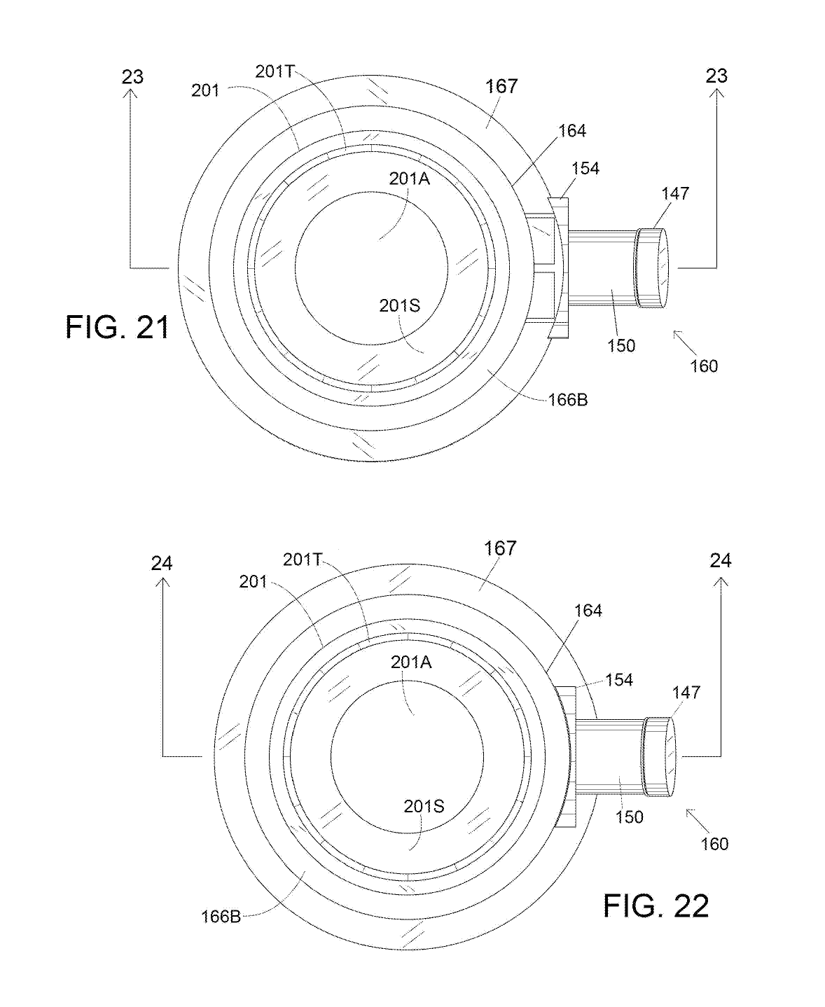

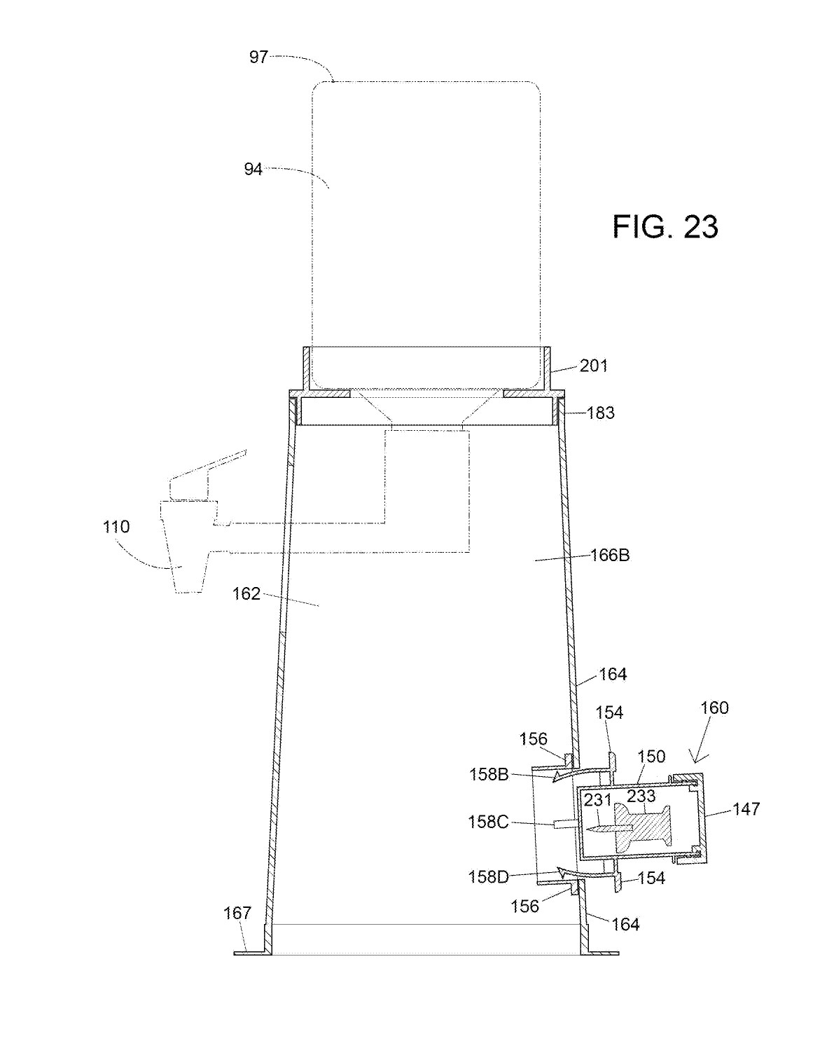

Referring to FIG. 21, a top view of the dispenser may be shown. The circular top enclosure 201T, a center aperture 201A, and a bottle seat 201S of bottle collar 201 may be seen in the present embodiment. The threaded cylinder 150 of the front plate 154, the bottle cap 147, and the base foot 167 of base 166B may also be seen. The front plate 154 of the retaining device 160 may be partially entered through a dispenser base wall 164, and may illustrate the flexing of barbed fastening arm 158B and a barbed fastening arm 158D of FIG. 23.

Referring to FIG. 22 another top view of the dispenser may be seen. The front plate 154 of the retaining device 160 (FIGS. 19 and 20) may be clamped into position onto the dispenser base wall 164. The circular top enclosure 201T, the center aperture 201A, and bottle seat 201S of bottle collar 201 may be seen. The threaded cylinder 150, the bottle cap 147, and the base foot 167 of the base 166B may also be seen.

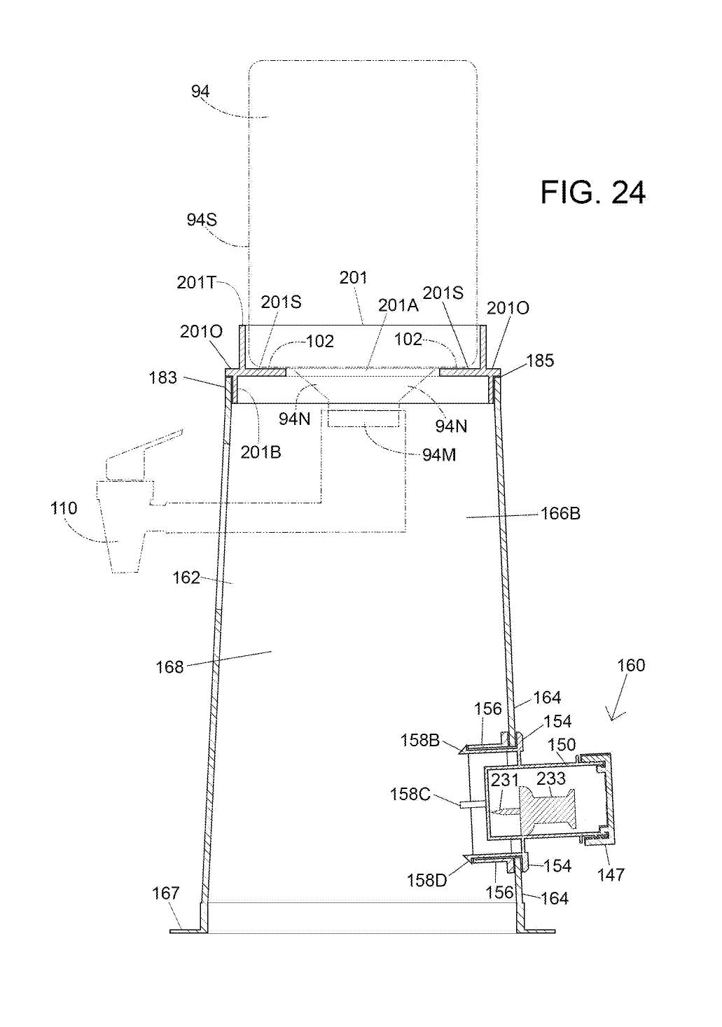

Referring to FIG. 23, a sectional view of the dispenser may be seen. In the present embodiment, the bottle collar 201 may support the supply bottle 94. The bottle collar 201 may be removably engaged upon the base rim 183 of the base 166B. The base foot 167 may also be seen. The front plate 154 of the retaining device 160 may be partially entered into the rear mounting plate 156 to illustrate the flexing of two of the four barbed fastening arms 158B and 158D of the front plate 154 prior to being locked into place as shown in FIG. 24. A 3^{rd} barbed fastening arm 158C may be flexed, and the 4^{th} barbed fastening arm 158A (FIGS. 19 and 20) may be flexed, but not illustrated because it may have been cut out of this FIG. 23 sectional view. All four barbed fastening arms 158A, again referring to FIGS. 19 and 20, 158B, 158C and 158D may be part of the structure of the front plate 154. The piercing tool 233 may be used for administering a vent hole 97 in the supply bottle 94. The piercing tool 233 and the piercing tool spike 231 thereof may be located inside of the threaded cylinder 150 of the front plate 154. The bottle cap 147 from the supply bottle 94 may be threadably secured onto the threaded cylinder 150 of the front plate 154. The base wall 164 of the base 166B may be positioned between the rear mounting plate 156 and the front plate 154. The dispenser valve 110 may be seen as extending through the bottle valve window 162.

Referring to FIG. 24, another sectional view of the dispenser may be seen. The circular top enclosure 201T of the bottle collar 201 may be formed to engage the circular body of the supply bottle 94. The circular top enclosure 201T may surround a portion of a sidewall 94S of the circular body of the circular supply bottle 94. The circular top enclosure 201T may be formed to restrict a lateral movement of the supply bottle 94 inverted and positioned therein. The bottle seat 201S of the bottle collar 201 may merge with the circular top enclosure 201T. The bottle seat 201S may be formed to removably engage the supply bottle 94 on a shoulder 102 thereof. The bottle seat 201S may have the center aperture 201A where an angled neck 94N and the mouth 94M of the supply bottle 94 may extend there through when the supply bottle is inverted and positioned thereon. The outer portion 201O of the bottle collar 201 may merge with the bottle seat 201S and the bottom of the circular top enclosure 201T of the bottle collar 201. The outer portion 201O of the bottle collar 201 may be formed to removably engage upon the rim top 185 of the rim 183. Thus the bottle collar 201 may be removably engaged upon rim 183. The bottom ring 201B may merge with the outer portion 201O of the bottle collar 201. The bottom ring 201B may be positioned on the inside of the rim 183, and may be formed to restrict a lateral movement of the bottle collar 201 upon rim 183. The bottom ring 201B could also be formed on the outside of rim 183 to restrict the lateral movement of the bottle collar 201 upon rim 183.

The front plate 154 may be locked into position by four barbed fastening arms 158A of FIGS. 19 and 20, 158B, 158C, and 158D, into the rear mounting plate 156. While the present embodiment discloses four barbed fastening arms 158A of FIGS. 19 and 20, 158B, 158C, and 158D, this is for illustrative purposes only and differing numbers of barbed fastening arms may be used without departing from the spirit and scope of the present invention. The base wall 164 of the base 166B may be positioned between the front plate 154 and the rear mounting plate 156. The base wall 164 may support the front plate 154 and the rear mounting plate 156 of retaining device 160. The piercing tool 233 and the piercing tool spike 231 may be located inside of the threaded cylinder 150 of the front plate 154. The bottle cap 147 may be threaded into position onto the threaded cylinder 150 of the front plate 154. The dispenser valve 110 may be seen extending from a base cavity 168 and through the base window 162 to a location outside the base 166B. The base foot 167 may be formed at the bottom of base 166B.

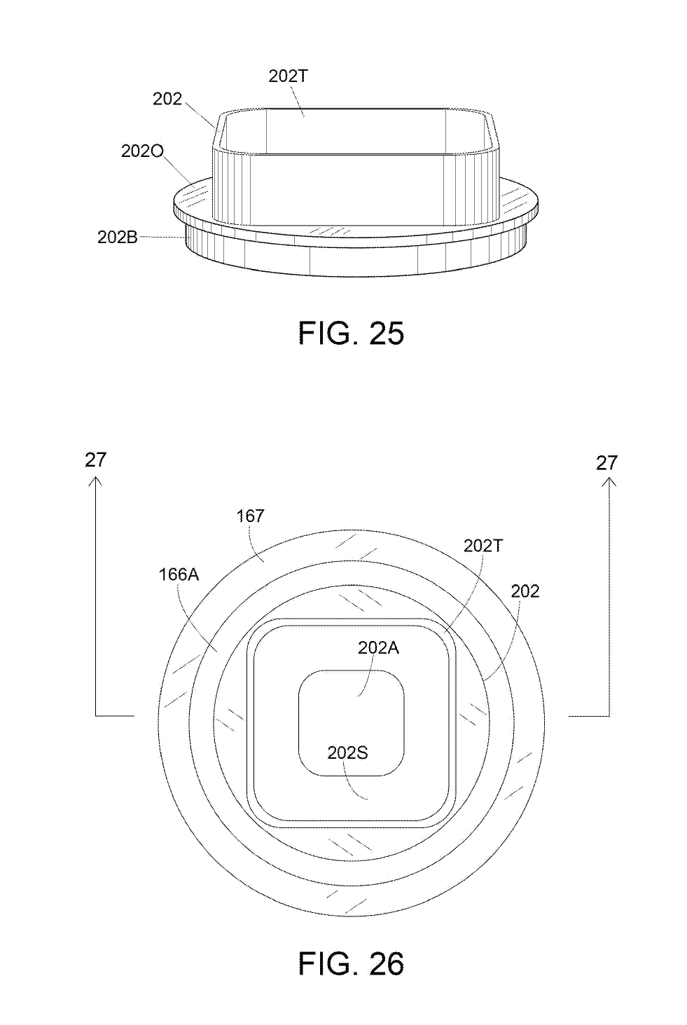

Referring to FIG. 25, a perspective view of another embodiment of a removable bottle collar, a removable bottle collar 202 (hereinafter bottle collar 202) may be seen. A rounded rectangular top enclosure 202T of the bottle collar 202 may be formed to engage a rounded rectangular body of supply bottle 95 as shown in FIG. 28. The outer portion 202O, and a bottom ring 202B of bottle collar 202 may be seen.

Referring to FIG. 26, a top view of the rounded rectangular top enclosure 202T, a center aperture 202A, and a bottle seat 202S of the bottle collar 202 may be seen. The bottle collar 202 being removably engaged upon base 166A may be seen. In the present embodiment, the base 166A may be cylindrical in shape. However, this is shown as one example and the base 166A may be formed into other geometrical shapes and sizes. As shown in FIG. 26, the base 166A may be tapered. Thus, a bottom portion of the base 166A may be wider than an upper portion of the base 166A. The tapered nature of the base 166A may provide added stability, and may allow for the base to be stacked. The base 166A may have a base foot 167 formed on a bottom portion thereof.

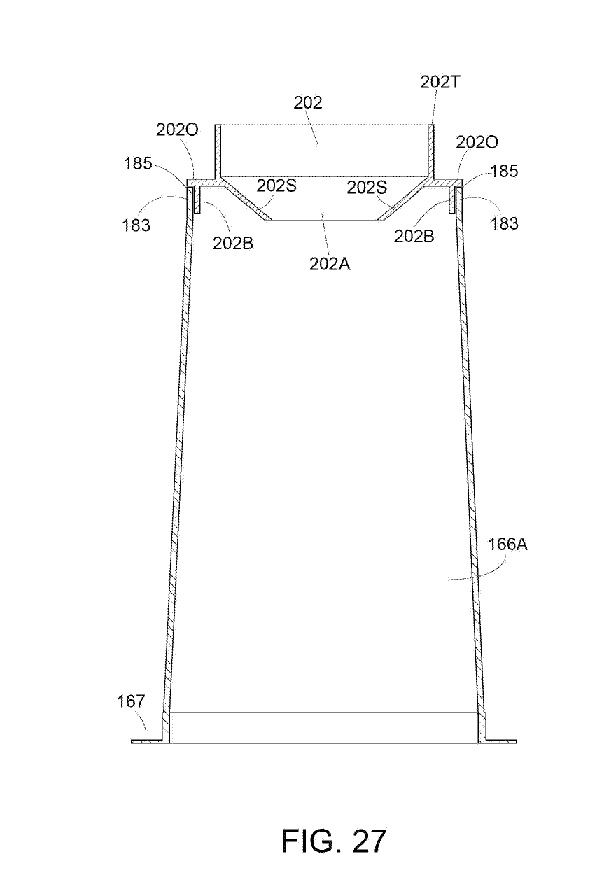

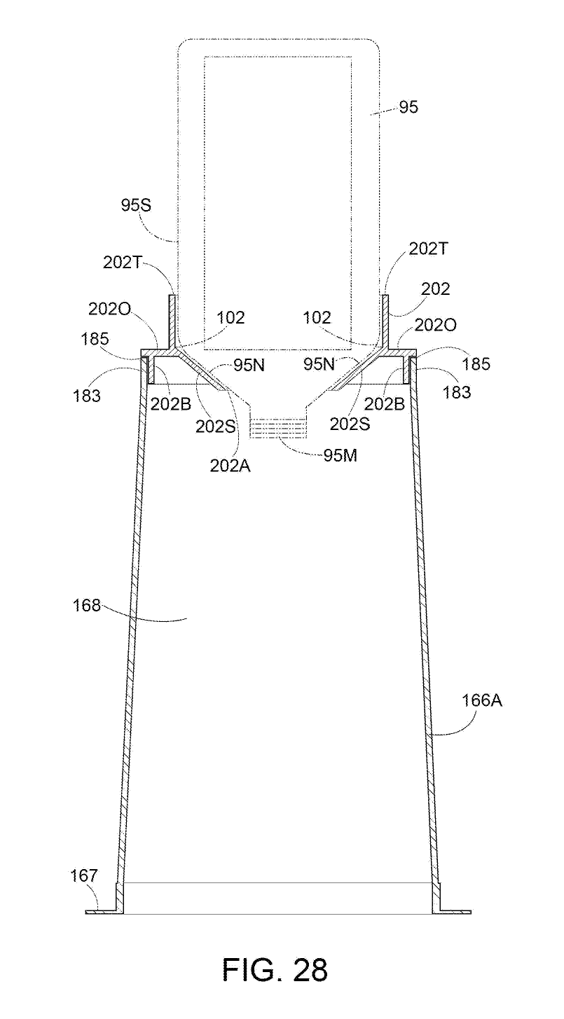

Referring to FIG. 27, a sectional view may be seen illustrating the base 166A with the base foot 167 fitted with the bottle collar 202. The outer portion 202O of bottle collar 202 may be removably engaged upon the base rim top 185 of the base rim 183. The bottom ring 202B may restrict lateral movement of the bottle collar 202 while engaged upon base rim top 185 of the base rim 183. The bottle seat 202S may merge with a bottom of the rounded rectangular top enclosure 202T. The bottle seat 202S of the bottle collar 202 may be angled. The bottle seat 202S may removably engage a portion of an angled neck 95N of the supply bottle 95 as shown in FIG. 28. The other portion of the neck 95N of the supply bottle 95 may extend there through the center aperture 202A. The bottle seat 202S of the bottle collar 202 may removably engage the supply bottle 95 of FIG. 28.

Referring to FIG. 28, a sectional view of the base foot 167 of the base 166A, and the bottle collar 202 may be seen. The rounded rectangular top enclosure 202T of the bottle collar 202 may be formed to engage the rounded rectangular body of the supply bottle 95. The rounded rectangular top enclosure 202T may surround a portion of a sidewall 95S of the body of the supply bottle 95. The rounded rectangular top enclosure 202T may be formed to restrict lateral movement of the supply bottle 95 inverted and positioned therein. The bottle seat 95S may merge with the top enclosure 202T. The bottle seat 95S may be formed to removably engage the supply bottle 95 on a portion of the angled neck 95N thereof. The angled neck of supply bottle 95 begins at the shoulder 102 of the supply bottle 95. The bottle seat 202S may have the center aperture 202A where a mouth 95M of the supply bottle 95 may extend there through into the base cavity 168 when the supply bottle 95 may be inverted and positioned thereon. The outer portion 202O of the bottle collar 202 may merge with the bottle seat 202S and the rounded rectangular top enclosure 202T of bottle collar 202. The outer portion 202O of bottle collar 202 may be formed to removably engage upon the rim top 185 of rim 183. Thus the bottle collar 202 may be removably engaged upon rim 183. The bottom ring 202B may merge with the outer portion 202O of the bottle collar 202. The bottom ring 202B may be positioned on the inside of rim 183, and may be formed to restrict a lateral movement of the bottle collar 202 upon the rim 183. The bottom ring 202B could also be formed on the outside of the rim 183 to restrict the lateral movement of the bottle collar 202 upon the rim 183 The sectional view of the bottle collar 202 could also represent a sectional view of a bottle collar formed for a bottle (not shown) with a circular body like the supply bottle of 94 FIG. 18, but having the angled neck 95N like the neck of supply bottle 95.

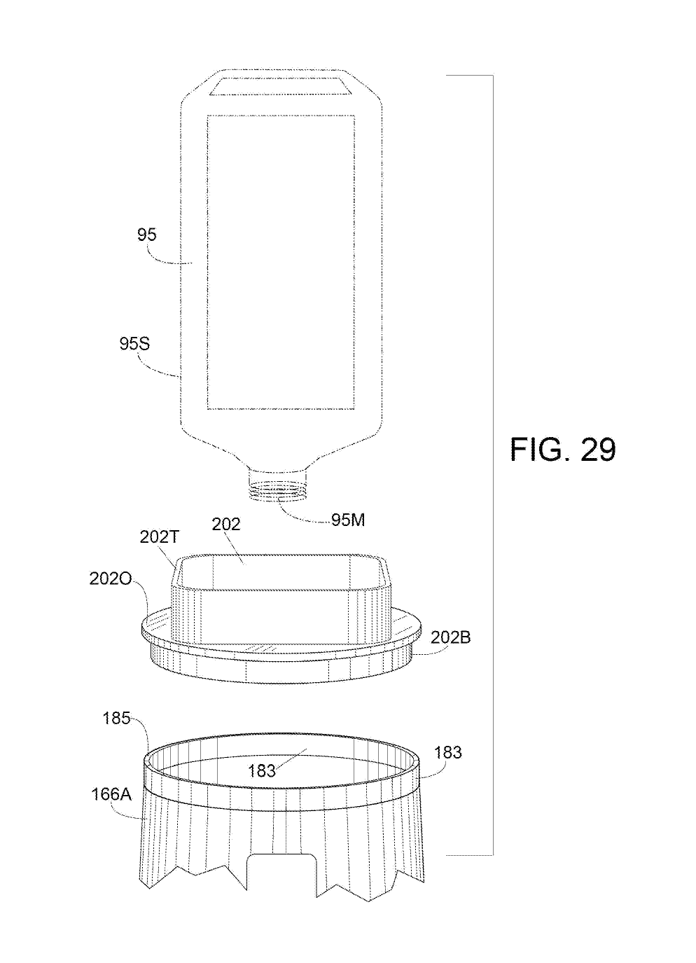

A broken exploded view of FIG. 28 may be seen in FIG. 29. Starting at the bottom of FIG. 29, one may see the base 166A, the rim 183, and the rim top 185. Looking at the bottle collar 202, the outer portion 202O of the bottle collar 202 may be seen. The outer portion 202O of bottle collar 202 may be removably engaged upon the rim top 185 of the rim 183. The bottom ring 202B may restrict lateral movement of bottle collar 202 while engaged upon rim top 185 of rim 183. The bottle collar 202 may engage and support the supply bottle 95 while inverted and positioned within the rim 183. The rounded rectangular top enclosure 202T may be formed to engage the supply bottle and restrict a lateral movement of the supply bottle inverted and positioned therein. A portion of the sidewall 95S of the body of the supply bottle 95 may be surrounded by the rounded rectangular top enclosure 202T. The bottle mouth 95M may be seen in the present embodiment.

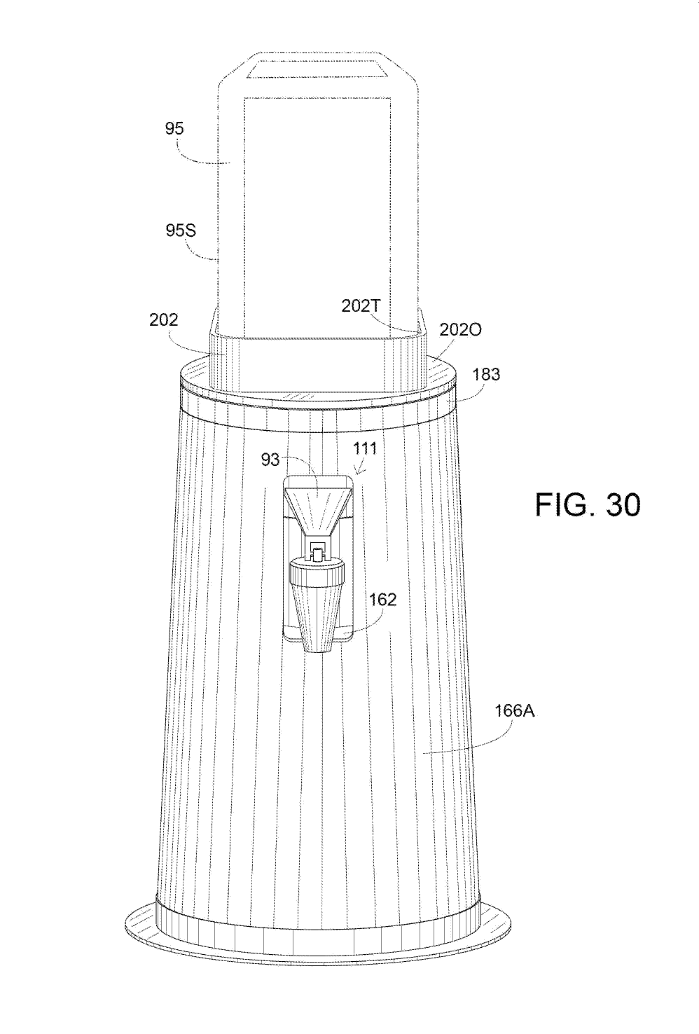

Referring to FIG. 30, a perspective front view of the dispenser may be seen. The bottle collar 202 may be seen removably engaged upon the rim 183 of base 166A. The bottle collar 202 may be adapted to engage and support the supply bottle 95 while the supply bottle 95 may be inverted and positioned within the rim 183. A portion of the sidewall 95S of the supply bottle 95 may be surrounded by the rounded rectangular top enclosure 202T. The outer portion 202O of bottle collar 202 may be removably engaged upon the rim 183 of the base 166A. The liquid (hereinafter water) from supply bottle 95 may be delivered from the mouth 95M (FIG. 29) of the supply bottle 95, through the base window 162 formed in base 166A, and to a location outside of the base 166A when the valve activation lever 93 of dispenser valve 111 is activated.

Referring to FIGS. 18, 23, and 24, operation and use of the dispenser may be described. To begin with, the base 166B of the dispenser of FIG. 18 may be placed on its side onto a countertop or desktop. The rear mounting plate 156 of FIG. 23 may be placed in the inside of the base 166B and pressed up against the retaining device void 152 of FIG. 15. The front plate 154 of FIG. 23 may be inserted into the rear mounting plate 156 until all four barbed fastening arms 158A, 158B, 158C, and 158D of the front plate 154 are locked into position against the rear mounting plate 156 referring to FIGS. 20 and 24. The base 166B may then be placed in an upright position onto a countertop, desktop, floor or other dispensing surface. The bottle collar 201 may be removably engaged into position upon the base rim 183 of base 166B of FIG. 18.

The dispenser valve 110 may be installed onto the supply bottle 94 of FIG. 18, and then the supply bottle 94 with the dispenser valve 110 attached may be inverted and removably engaged into the bottle collar 201. One may need to make sure that the dispenser valve 110 passes through the bottle valve window 162 as illustrated in FIG. 18. At this point, a vent hole 97 may be administered in the supply bottle 94. The piercing tool spike 231 of the piercing tool 233 of FIG. 24 may be used to puncture a portion of the supply bottle 94 forming the vent hole 97 of FIG. 18. The vent hole 97 may vent the supply bottle 94 to atmosphere. When the vent hole 97 is administered, the piercing tool 233 may be placed inside the threaded cylinder 150 of the retaining device 160 of FIG. 24, and the bottle cap 147 may be threadably secured onto the threaded cylinder 150. It may be noted that the user may have the choice between using either the bottle cap 147 that was removed from the supply bottle 94, or the bottle cap 147 that is included in the retaining device assembly 160. The supply bottle 94 may now dispense and serve water. It should be noted that if the dispenser valve 111 were to be used in place of dispenser valve 110, the vent hole 97 might not be needed.

Referring to FIG. 30, operation of the dispenser with the base 166A having no piercing tool may be disclosed. To begin with, the base 166A of the dispenser of FIG. 30 may be placed in an upright position onto a countertop, desktop, floor or other dispensing surface. The bottle collar 202 may be removably engaged upon the base rim 183 of base 166A as in shown in FIG. 30. The dispenser valve 111 may be installed onto the supply bottle 95 when the bottle is placed in an upright position. The supply bottle 95 with the dispenser valve 111 attached may be inverted and positioned to be removably engaged into the bottle collar 202 making sure that the dispenser valve 111 passes through the bottle valve window 162 as may be seen in FIG. 30. The supply bottle 95 may then be used to serve and dispense water by activating valve activation lever 93 of dispenser valve 111.

The dispenser of the present invention provides numerous advantages. The dispenser accommodates a variety of commercial water bottles that currently have no valve dispensers. The dispenser may provide a dispenser valve 110 and/or a dispenser valve 111. The dispenser may use the dispenser valve 110 that has a reservoir 81. The reservoir 81 may be provided to store water transferred from the supply bottle. The water transferred from the supply bottle to the reservoir 81 in the dispenser valve 110 may cause the water level in the supply bottle to drop to a predetermined level. The dropped water level in the supply bottle may allow for a vent hole to be administered in the supply bottle without water escaping from the vent hole. Alternatively, the dispenser valve 111 may be provided that may allow for the supply bottle to be set upright and placed in a refrigerator, wherein a venting hole may not be needed in the supply bottle.

The dispenser valves 110 and 111 may be easily installed onto different water bottles. Once the dispenser valve 110 or dispenser valve 111 is installed, the water bottle may be easily inserted into the base 166A or the base 166B. A retaining device 160 may be attached to the base 166B. The retaining device 160 may have a threaded cylinder 150 that may store a piercing tool 233. The piercing tool 233 may be readily available to vent the supply bottle used with base 166B. The bottle cap 147 of the inverted supply bottle may be threadably attached to the threaded cylinder 150 of the retaining device 160. The retaining device 160 may prevent the bottle cap 147 from becoming lost.

The dispenser generally requires no cleaning as water is dispensed directly from the single use water bottles. Spillage of water is generally unlikely from the mouth of the water bottle as the dispenser valve 110 and/or dispenser valve 111 may be installed prior to lifting of the water bottle, so the bottle wall generally will not push in and force water out of the mouth of the water bottle. Further water contamination of the bottled water is unlikely as the water is received through the dispenser valve 110 and/or dispenser valve 111. The dispenser may allow for smaller quantities of the 4 oz. to 24 oz. water bottles to be used since the dispenser may allow for more “gallon” or larger jugs to be used in households and may lead to an improvement in the environment.

While embodiments of the disclosure have been described in terms of various specific embodiments, those skilled in the art will recognize that the embodiments of the disclosure may be practiced with modifications within the spirit and scope of the claims. For example, other embodiments of valves/connectors may be used to dispense water from the water bottle. Different embodiments of piercing tools as well as different embodiments of mounting devices for the piercing tools may be used. Also, the base could take on additional geometrical shapes/sizes other than the shape of the dispenser base mentioned in the above description. Furthermore, the dispenser could be used with inverted beverage bottles in addition to inverted water bottles. Accordingly, the scope should be determined not by the specific embodiments illustrated, but by the appended claims and their legal equivalents.

### DRAWINGS

### Reference Numbers

70—removable dispenser valve
77—valve body outlet port
78—component compartment
78T—component compartment top
81—reservoir
82—threaded inlet port top
83—valve body inlet port
84—vent tube
84A—vent tube inlet port
84B—barbed vent tube port
85—seat cup
85W—seat cup wall
87—sealing seat
89—peg
89B—peg base
89S—spring base
89R—right pin slot
89L—left pin slot
90—coiled spring
91—component compartment bonnet
92—peg aperture
93—valve activation lever
93R—valve activation lever right pin
93L—valve activation lever left pin
94—circular supply bottle
94M—bottle mouth
94N—bottleneck
94S—bottle sidewall
95—rounded rectangular supply bottle
95S—bottle sidewall
96—threaded bottle mouth
97—vent hole
98—water level
99B—bottom tube
99T—top tube
100—check valve
100T—top barbed outlet
100B—bottom barbed inlet
101—tube outlet
102—bottle shoulder
103—bottle union
103T—union
103B—union bottom
105—bottle union
105T—union top
105B—union bottom
107—bottle union
107T—union top
107B—union bottom
109—alternative bottle union
109T—alterative bottle union top
109B—alternative bottle union bottom
110—reservoir dispenser valve assembly. Reservoir dispenser valve assembly 110 includes the following parts: valve body 110B, seat cup 85, peg 86, coil spring 90, component compartment bonnet 91, valve activation lever 93, bottle union 103
110B—valve body
111—vented dispenser valve assembly. Vented dispenser assembly 111 includes the following parts: valve body 111B, seat cup 85, peg 86, coil spring 90, component compartment bonnet 91, valve activation lever 93, bottle union 103
111B—valve body
145—cup
147—bottle cap
150—threaded cylinder
152—retaining device void
154—front plate
156—rear mounting plate
158A—barbed fastening arm
158B—barbed fastening arm
158C—barbed fastening arm
158D—barbed fastening arm
160—retaining device assembly (used with base 166B of the dispenser) Retaining device assembly 160 includes the following parts: front plate 154, rear mounting plate 156, piercing tool 233, and bottle cap 147
162—bottle valve window
164—base wall
166A—base (bottle valve window 162 only)
166B—base (bottle valve window 162 and retaining device void 152)
167—base foot
168—base cavity
183—base rim
187—base rim sidewall
185—base rim top
189—spacer
195B—bottom obstruction
195T—top obstruction
197—bottle collar outer portion
199—bottle seat
201—removable bottle collar
201A—center aperture
201B—bottom ring
201O—bottle collar outer portion
201S—bottle seat
201T—circular top enclosure
202—removable bottle collar
202A—center aperture
202B—bottom ring
202O—bottle collar outer portion
202S—bottle seat
202T—rounded rectangular top enclosure
203—center aperture
231—piercing tool spike
233—piercing tool

1-26. (canceled)

27. A dispenser for delivering a liquid from a supply bottle comprising:
a base having a hollow interior, the base having a rim formed at a top portion of the base, a foot formed at a bottom portion of the base, a window formed in the base; and
a removable bottle collar engaging with the base and adapted to engage and support the supply bottle inverted and positioned within the rim, the removable bottle collar having a center aperture where a mouth of the supply bottle extends there through, the liquid from the supply bottle being delivered from the mouth of the supply bottle through the base window to a location outside of the base.

28. The dispenser of claim 27 comprising a retaining device attached to the base, the retaining device having a threaded cylinder for storing a piercing tool for administering a vent hole in the supply bottle, wherein a bottle cap removed from the supply bottle is threadably secured to the threaded cylinder.

29. The dispenser of claim 27 wherein the removable bottle collar comprises:
a rounded rectangular top enclosure formed to engage a rounded rectangular body of the supply bottle, the rounded rectangular top enclosure surrounding a portion of a sidewall of the supply bottle and restricting a lateral movement of the supply bottle inverted and positioned therein;
a bottle seat merging with the top enclosure and formed to removably engage the supply bottle on a neck thereof, the bottle seat having the center aperture where the mouth of the supply bottle extends there through when the supply bottle is inverted and positioned thereon; and
an outer portion merging with the bottle seat, the outer portion formed to be removably engaged upon the base.

30. The dispenser of claim 27 wherein the removable bottle collar comprises:
a circular top enclosure formed to engage a circular body of the supply bottle, the circular top enclosure surrounding a portion of a sidewall of the supply bottle and restricting a lateral movement of the supply bottle inverted and positioned therein;
a bottle seat merging with the top enclosure and formed to removably engage the supply bottle on a shoulder thereof, the bottle seat having the center aperture where the mouth of the supply bottle extends there through when the supply bottle is inverted and positioned thereon; and
an outer portion merging with the bottle seat, the outer portion formed to be removably engaged upon the base.

31. The dispenser of claim 27 wherein the removable bottle collar comprises:
a circular top enclosure formed to engage a circular body of the supply bottle, the circular top enclosure surrounding a portion of a sidewall of the supply bottle and restricting a lateral movement of the supply bottle inverted and positioned therein;
a bottle seat merging with the top enclosure and formed to removably engage the supply bottle on a neck thereof, the bottle seat having the center aperture where the mouth of the supply bottle extends there through when the supply bottle is inverted and positioned thereon; and
an outer portion merging with the bottle seat, the outer portion formed to be removably engaged upon the base.

32. The dispenser of claim 27 wherein the removable bottle collar comprises:
a rounded rectangular top enclosure formed to engage a rounded rectangular body of the supply bottle, the rounded rectangular top enclosure surrounding a portion of a sidewall of the supply bottle and restricting a lateral movement of the supply bottle inverted and positioned therein;
a bottle seat merging with the top enclosure and formed to removably engage the supply bottle on a neck thereof, the bottle seat having the center aperture where the mouth of the supply bottle extends there through when the supply bottle is inverted and positioned thereon;
an outer portion merging with the bottle seat, the outer portion formed to be removably engaged upon the base; and
a retaining device attached to the base, the retaining device having a threaded cylinder for storing a piercing tool for administering a vent hole in the supply bottle, wherein a bottle cap removed from the supply bottle is threadably secured to the threaded cylinder.

33. The dispenser of claim 27 wherein the removable bottle collar comprises:
a circular top enclosure formed to engage a circular body of the supply bottle, the circular top enclosure surrounding a portion of a sidewall of the supply bottle and restricting a lateral movement of the supply bottle inverted and positioned therein;
a bottle seat merging with the top enclosure and formed to removably the supply bottle on a shoulder thereof, the bottle seat having the center aperture where the mouth of the supply bottle extends there through when the supply bottle is inverted and positioned thereon;
an outer portion merging with the bottle seat, the outer portion formed to be removably engaged upon the base; and
a retaining device attached to the base, the retaining device having a threaded cylinder for storing a piercing tool for administering a vent hole in the supply bottle, wherein a bottle cap removed from the supply bottle is threadably secured to the threaded cylinder.

34. The dispenser of claim 27 wherein the removable bottle collar comprises:
a circular top enclosure formed to engage a circular body of the supply bottle, the circular top enclosure surrounding a portion of a sidewall of the supply bottle and restricting a lateral movement of the supply bottle inverted and positioned therein;
a bottle seat merging with the top enclosure and formed to removably engage the supply bottle on a neck thereof, the bottle seat having the center aperture where the mouth of the supply bottle extends there through when the supply bottle is inverted and positioned thereon;
an outer portion merging with the bottle seat, the outer portion formed to be removably engaged upon the base; and
a retaining device attached to the base, the retaining device having a threaded cylinder for storing a piercing tool for administering a vent hole in the supply bottle, wherein a bottle cap removed from the supply bottle is threadably secured to the threaded cylinder.

35. The dispenser of claim 27 comprising a dispenser valve removably coupled to the mouth of the supply bottle, the dispenser valve controlling a flow of liquid from the supply bottle and delivering the liquid through the base window to a location outside of the base.

36. The dispenser of claim 27, comprising:
a retaining device attached to the base, the retaining device having a threaded cylinder for storing a piercing tool for administering a vent hole in the supply bottle, wherein a bottle cap removed from the supply bottle is threadably secured to the threaded cylinder;
a dispenser valve removably coupled to the mouth of the supply bottle, the dispenser valve controlling a flow of the liquid from the supply bottle and delivering the liquid through the base window to a location outside of the base; and
a vent tube in a valve body of the dispenser valve that begins at a vent tube inlet port in the valve body, with the vent tube having a barbed vent tube port that couples to a tube, the tube coupled to a check valve.

37. The dispenser of claim 27, comprising:
a retaining device attached to the base, the retaining device having a threaded cylinder for storing a piercing tool for administering a vent hole in the supply bottle, wherein a bottle cap removed from the supply bottle is threadably secured to the threaded cylinder;
a dispenser valve removably coupled to the mouth of the supply bottle, the dispenser valve controlling a flow of the liquid from the supply bottle and delivering the liquid through the base window to a location outside of the base; and
a reservoir in liquid communication with a valve body inlet port and a valve body outlet port in a valve body of the dispenser valve that stores a predetermined quantity of the liquid transferred from the supply bottle coupled to the dispenser valve causing a liquid level in the supply bottle to drop to a predetermined level allowing for the vent hole to be administered in the supply bottle.

38. A dispenser for delivering a liquid from a supply bottle comprising:
a walled base having a hollow interior, a rim formed at a top portion of the walled base, a foot formed at a bottom portion of the walled base, a window formed in the walled base; and
a removable bottle collar engaging with the walled base and adapted to engage and support the supply bottle inverted and positioned within the rim, the removable bottle collar having a center aperture where a mouth of the supply bottle extends there through, the liquid from the supply bottle being delivered from the mouth of the supply bottle, through the walled base window to a location outside of the walled base, the removable bottle collar comprising:
a top enclosure formed to engage the supply bottle, the top enclosure surrounding a portion of a sidewall of the supply bottle and restricting a lateral movement of the supply bottle inverted and positioned therein;
a bottle seat merging with the top enclosure and formed to removably engage the supply bottle, the bottle seat having the center aperture where the mouth of the supply bottle extends there through when the supply bottle is inverted and positioned thereon; and
an outer portion merging with the bottle seat, the outer portion formed to be removably engaged upon the base.

39. The dispenser of claim 38 comprising a retaining device attached to the walled base, the retaining device having a threaded cylinder for storing a piercing tool for administering a vent hole in the supply bottle, wherein a bottle cap removed from the supply bottle is threadably secured to the threaded cylinder.

40. The dispenser of claim 38 wherein the top enclosure is formed as a rounded rectangular top enclosure to engage a rounded rectangular body of the supply bottle, and the bottle seat is formed to removably engage the supply bottle on a neck thereof.

41. The dispenser of claim 38 wherein the top enclosure is formed as a circular top enclosure to engage a circular body of the supply bottle, and the bottle seat is formed to removably engage the supply bottle on a shoulder thereof.

42. The dispenser of claim 38 wherein the top enclosure is formed as a circular top enclosure to engage a circular body of the supply bottle, and the bottle seat is formed to removably engage the supply bottle on a neck thereof.

43. The dispenser of claim 38 wherein the top enclosure is formed as a rounded rectangular top enclosure to engage a rounded rectangular body of the supply bottle, and the bottle seat is formed to removably engage the supply bottle on a neck thereof; and
a retaining device attached to the walled base, the retaining device having a threaded cylinder for storing a piercing tool for administering a vent hole in the supply bottle, wherein a bottle cap removed from the supply bottle is threadably secured to the threaded cylinder.

44. The dispenser of claim 38 wherein the top enclosure is formed as a circular top enclosure to engage a circular body of the supply bottle, and the bottle seat is formed to removably engage the supply bottle on a shoulder thereof; and
a retaining device attached to the walled base, the retaining device having a threaded cylinder for storing a piercing tool for administering a vent hole in the supply bottle, wherein a bottle cap removed from the supply bottle is threadably secured to the threaded cylinder.

45. The dispenser of claim 38 wherein the top enclosure is formed as a circular top enclosure to engage a circular body of the supply bottle, and the bottle seat is formed to removably engage the supply bottle on a neck thereof; and
a retaining device attached to the walled base, the retaining device having a threaded cylinder for storing a piercing tool for administering a vent hole in the supply bottle, wherein a bottle cap removed from the supply bottle is threadably secured to the threaded cylinder.

46. The dispenser of claim 38 comprising a dispenser valve removably coupled to the mouth of the supply bottle, the dispenser valve controlling a flow of the liquid from the supply bottle and delivering the liquid through the walled base window to a location outside of the walled base.

47. The dispenser of claim 38, comprising:
a retaining device attached to the walled base, the retaining device having a threaded cylinder for storing a piercing tool for administering a vent hole in the supply bottle, wherein a bottle cap removed from the supply bottle is threadably secured to the threaded cylinder;
a dispenser valve removably coupled to the mouth of the supply bottle, the dispenser valve controlling a flow of the liquid from the supply bottle and delivering the liquid through the walled base window to a location outside of the walled base; and
a vent tube in a valve body of the dispenser valve that begins at a vent tube inlet port in the valve body, with the vent tube having a barbed vent tube port that couples to a tube, the tube coupled to a check valve.

48. The dispenser of claim 38, comprising:
a retaining device attached to the walled base, the retaining device having a threaded cylinder for storing a piercing tool for administering a vent hole in the supply bottle, wherein a bottle cap removed from the supply bottle is threadably secured to the threaded cylinder;
a dispenser valve removably coupled to the mouth of the supply bottle, the dispenser valve controlling a flow of the liquid from the supply bottle and delivering the liquid through the walled base window to a location outside of the walled base; and
a reservoir in liquid communication with a valve body inlet port and a valve body outlet port in a valve body of the dispenser valve that stores a predetermined quantity of the liquid transferred from the supply bottle coupled to the dispenser valve causing a liquid level in the supply bottle to drop to a predetermined level allowing for the vent hole to be administered in the supply bottle.

49. A dispenser for delivering a liquid from an inverted supply bottle comprising:
a dispenser valve comprising:
a. a valve body comprising:
1. an inlet port having a threaded inlet port top;
2. an outlet port in liquid communication with the inlet port, the outlet port located to a side of the inlet port when the dispenser valve is coupled to a mouth the inverted supply bottle;
3. a sealing seat in liquid communication with the inlet and outlet ports;
4. a component compartment having a threaded top;
b. a component compartment bonnet having a center aperture, the component compartment bonnet threadably secured to the threaded compartment top;
c. a seat cup contiguous with the component compartment bonnet, housed within the component compartment, controlling the flow of liquid through the dispenser valve, the liquid flowing through the dispenser valve halted when the seat cup is urged upon the sealing seat;
d. a peg housed within the component compartment, a base of the peg anchored within the seat cup, and a slotted end of the peg extending through the aperture in the component compartment bonnet;
e. a coil spring surrounding the peg, housed within the component compartment, and contiguous with a spring base of the peg and the component compartment bonnet, urging the seat cup against the sealing seat thus halting the flow of the liquid through the dispenser valve when the dispenser valve is inactive;
f. a valve activation lever attached to the slotted end of the peg that pulls the peg further through the component compartment bonnet when activated, compresses the coil spring, and pulls the seat cup away from the sealing seat thus enabling the liquid to flow through the dispenser valve;
g. a vent tube in the valve body that begins at a vent tube inlet port in the valve body, the vent tube having a barbed vent tube port that couples to a tube, the tube coupled to a check valve; and
a union threadably securing the threaded inlet port top to the mouth of the inverted supply bottle.

50. A dispenser for delivering a liquid from a supply bottle comprising:
a walled base having a hollow interior and a rim;
a removable bottle collar engaging with the walled base and adapted to engage and support the supply bottle inverted and positioned within the rim, the removable bottle collar having a center aperture where a mouth of the supply bottle extends there through.

51. The dispenser of claim 50, comprising:
a retaining device attached to the walled base, the retaining device having a threaded cylinder for storing a piercing tool for administering a vent hole in the supply bottle, wherein a bottle cap removed from the supply bottle is threadably secured to the threaded cylinder.
